(19) United States
(12) Patent Application Publication
(10) Pub. No.: US 2024/0111492 A1
(43) Pub. Date: Apr. 4, 2024

(54) Multiply-Accumulate with Configurable Conversion Between Normalized and Non-Normalized Floating-Point Formats

(71) Applicant: Flex Logix Technologies, Inc., Mountain View, CA (US)

(72) Inventors: Frederick A. Ware, Los Altos Hills, CA (US); Cheng C. Wang, Los Altos, CA (US)

(21) Appl. No.: 18/373,453

(22) Filed: Sep. 27, 2023

Related U.S. Application Data
(60) Provisional application No. 63/410,483, filed on Sep. 27, 2022.
(60) Provisional application No. 63/410,495, filed on Sep. 27, 2022.
(60) Provisional application No. 63/410,508, filed on Sep. 27, 2022.

(51) Int. Cl. G06F 7/544; G06F 7/485; G06F 7/487

(52) U.S. Cl. CPC G06F 7/5443; G06F 7/485; G06F 7/4876

(57) ABSTRACT

An integrated circuit device includes operand storage circuitry to output first and second operands each having a first standard floating point format, multiplier circuitry to multiply the first and second operands to generate a multiplication product first having a second standard floating point format and product accumulation circuitry. The product accumulation circuitry reformats the multiplication product to coarse floating format having a reduced numeric range relative to the originally generated multiplication product and then adds the reformatted multiplication product to a previously generated accumulation value, also having the coarse floating point format, to generate an updated accumulation value having the coarse floating point format, storing the updated accumulation value in place of the previously generated accumulation value.

### CROSS REFERENCE TO RELATED APPLICATIONS

This application hereby incorporates by reference and claims the filing-date benefit of each of the following patent applications: U.S. provisional application No. 63/410,483 filed Sep. 27, 2022, U.S. provisional application No. 63/410,495 filed Sep. 27, 2022, and U.S. provisional application No. 63/410,508 filed Sep. 27, 2022.

### DRAWINGS

The various embodiments disclosed herein are illustrated by way of example, and not by way of limitation, in the figures of the accompanying drawings and in which like reference numerals refer to similar elements and in which:

FIG. 1 illustrates an embodiment of an integrated-circuit inferencing engine having hierarchically arranged broadcast-data TPUs (tensor processing units) together with supporting memory, interconnect circuitry and physical signaling interfaces;

FIG. 2 contrasts a multi-data tensor processing scheme with a broadcast-data tensor processing approach implemented within the TPUs of FIG. 1;

FIG. 3 illustrates an exemplary execution of the FIG. 2 broadcast data example within an exemplary set of four multiply-accumulate (MAC) processors, showing the cycle-by-cycle transition of the input data value and respective rows of the filter weight matrix applied within the MAC processors in each MAC operation;

FIG. 4 illustrates a more detailed embodiment of a broadcast-data TPU;

FIG. 5 presents an exemplary tensor processing operation executed via parallel component-tensor processing within the data-broadcasting TPUs of FIG. 1;

FIG. 6 illustrates exemplary numerical precision of data at various ingress/egress and internal points within a MAC processor implemented generally as discussed above, but having two L0 memory banks to enable one bank to be written concurrently with filter weight readout from the other;

FIG. 7 illustrates an alternative TPU embodiment having MAC processors that reduce area and power consumption by using a “coarse” floating point format for accumulated multiplication products;

FIG. 8A illustrates an embodiment of a logic circuit that may be deployed within the MAC-processor shift-out path to convert from coarse floating-point (FC) values to standard floating-point (FP) values;

FIG. 8B illustrates an embodiment of a logic circuit that may be deployed within the MAC-processor shift-in path and FC accumulator circuit shown in FIG. 7 to convert from standard floating-point values to coarse floating-point values;

FIGS. 9A and 9B illustrates exemplary numerical details of the FC and FP floating point formats discussed/illustrated with respect to TPU embodiments shown in FIGS. 7, 8A and 8B;

FIG. 10 illustrates an embodiment of a TPU (e.g., that may be deployed within the FIG. 1 inferencing engine) having an exemplary set of 64 broadcast-data MAC processors 351 coupled to form a MAC processing pipeline and NLINK circuitry having programmatically configurable FC-to-FP and FP-to-FC conversion blocks;

FIG. 11 illustrates a more detailed embodiment of the coarse floating-point adder/accumulator shown in FIG. 10;

FIG. 12 illustrates additional control logic detail with respect to the overflow/underflow detect circuitry and multiplexing circuitry shown in FIG. 11;

FIG. 13 illustrates an embodiment of the RshOut logic circuitry shown in FIG. 11;

FIG. 14 illustrates exemplary operations implemented by the result-rounding logic circuitry shown in FIG. 11;

FIG. 15 illustrates an embodiment of the exponent-overflow detection logic and corresponding multiplexing circuitry shown in FIG. 11;

FIG. 16 illustrates an example of the timing waveform for the operations described in reference to FIGS. 11-15;

FIG. 17 illustrates an example of the range of operands and results accumulated in an exemplary FC25 format;

FIG. 18 illustrates a more detailed embodiment of the bypass converter shown in FIG. 10;

FIG. 19 illustrates an exemplary floating point number space for the FP16

[symbol]

FIGS. 20-23 illustrate exemplary mapping from an FC25 format to an FP16 format; and

FIGS. 24-27 illustrate exemplary mapping from an FP16 format to an FC25 format.

### DETAILED DESCRIPTION

In various embodiments herein multiply-accumulate (MAC) processors within a tensor processing unit (TPU) simultaneously execute, in each of a sequence of MAC cycles, respective multiply operations using a shared (common) input data operand and respective weighting operands, each of the MAC processors applying a new shared input data operand and respective weighting operand in each successive MAC cycle to accumulate, as a component of an output tensor, a respective sum-of-multiplication-products. The shared-data TPU architecture—referred to herein as a broadcast-data architecture as each new input-data value is broadcast to data inputs of all constituent MAC processors of the TPU—provides a number of potential advantages relative to legacy multi-data architectures (i.e., in which each of N parallel MAC processors multiplies a respective one of N data values with a respective weighting operand during a given MAC cycle) including, for example and without limitation:
substantially reduced processing latency as shared input data may be loaded in parallel into all N MAC processors in a single clock cycle, avoiding the N clock-cycle load time required in multi-data architectures (e.g., shifting N data values into the N MAC processors over N successive clock cycles) and thus reducing end-to-end tensor processing latency by N−1 clock cycles;
obviated cycle-to-cycle data exchange between the MAC processors—no cycle-to-cycle shifting/rotating of different input data values between MAC processors (as required in a data-rotate multi-data TPU) or accumulated output data values between MAC processors (as required in an output-rotate multi-data TPU) and thus providing/enabling:
   improved timing margin (and therefore headroom for reduced MAC cycle time) relative to output-rotate architectures at least, by avoiding output rotation overhead within the summation/accumulation pipeline stage;
   input tensor depth (number of input data values, K, per input tensor or input sub-tensor) greater or less than per-TPU MAC processor count, N, as each MAC processor may execute an unlimited number (up to the point of numeric overflow) of multiply-accumulate operations to generate an output tensor result;
non-skewed (matrix-aligned) weighting operand storage within MAC processor memory, obviating circuitry generally required in multi-data TPU architectures to effect skewed storage of dynamically generated weight matrices.

In a number of embodiments, the decoupling of input tensor depth from TPU width (number of constituent MAC processors) enables more flexible mapping of input tensors to TPUs and/or simplified result aggregation/combination within sets of TPUs assigned to generate a given output tensor. In embodiments in which data propagation time over the broadcast data path (i.e., data path coupled to data inputs of respective MAC processors within a given TPU) exceeds the timing margin required for reliable capture within all MAC processors, the broadcast data path may be segmented by one or more pipe-stage registers, with upstream MAC processors including one or more additional input register stages to levelize the data input to the multiply stages within all MAC processors. In other embodiments, two or more broadcast data channels are supplied in parallel to the MAC processors within a given TPU, with each MAC processor including two or more multiply-accumulate units within each MAC processor (i.e., the per-processor MAC unit count corresponding to the number of parallel broadcast data channels). In such embodiments, a single, shared filter weight value may be multiplied with respective broadcast data values—one broadcast data value from each different data channel—within respective MAC units in each MAC cycle, thus effecting a single-weight, multi-broadcast data TPU architecture (SWMBD TPU) in which each MAC unit effectively implements a respective MAC channel. In a number of SWMBD embodiments, two or more broadcast data channels may convey constituent n-bit components of an N-bit value, where, for example, N=2n, 4n, 8n, etc. In those cases, referred to herein as single-weight, compound broadcast data (SWCBD), the MAC units (forming respective MAC channels) within a given processor may be inter-coupled to exchange partial multiplication results, carry data and so forth as necessary to effect significance-weighted multiply and accumulated operations (e.g., carry from multiply operation and summation operation MAC channel of lesser arithmetic significance to MAC channel of greater arithmetic significance). In other compound broadcast data embodiments, the MAC channels independently generate values of different arithmetic significance (no carry and/or partial results exchanged between MAC channels) with those values being combined in a final-accumulation stage, for example, within interface circuitry that links the TPU to other circuit blocks (including other TPUs) within the host integrated circuit device. In both compound and non-compound SWMBD embodiments, the decoupling of input tensor depth from per-TPU MAC processor count enables summation of MAC results from one or more serially-connected sets of multi-broadcast-data-channel TPUs, each vector-multiplying a complex filter weight input with a respective input subtensor, into a finite impulse response (FIR) filter output, implementing, for example, a convolutional neural network (CNN) capable of generating a matrix of FIR output subtensors over an N*logN multiply-accumulate cycles (N being the critical input/output matrix dimension) and thus dramatically faster than the N² (or longer) MAC cycles generally required by conventional CNN implementations. These and other features and embodiments are discussed in further detail below.

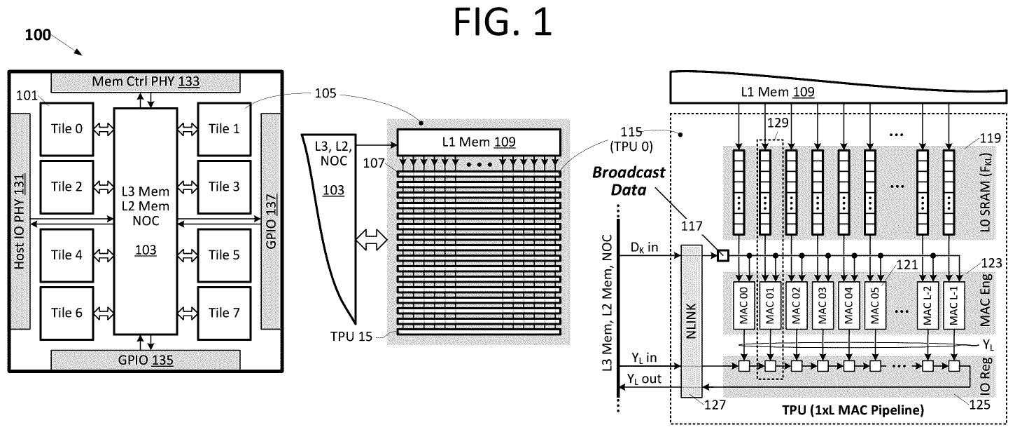

FIG. 1 illustrates an embodiment of an integrated-circuit inferencing engine 100 (“inferencing IC”) having broadcast-data TPUs grouped/clustered within processing tiles 101 and interconnected to one another, on-die memory and various physical signaling interfaces via a network-on-chip interconnect 103. In the depicted implementation, each of the processing tiles 101—shown for example in detail view 105—includes sixteen TPUs 107 (a x16 TPU cluster) coupled to receive filter weight values from a shared local (tile-resident) memory 109 referred to herein as level-one (L1) memory. Referring to the exemplary detail at 115, each TPU 107 includes a broadcast data register 117 and high-speed/low-latency filter-weight storage 119 (referred to herein as a level-zero (L0) memory), together with a bank of ‘L’ multiply-accumulate units 121 (collectively implementing a MAC engine 123), input/output (I/O) shift register 125, and linking logic 127 (“NLINK”), the latter for interfacing to the broadcast data register and I/O shift register to NOC 107 and thus to the progressively larger level-two and level-three memories (L2 and L3) and signaling PHYs. The collective circuit block shown at 129, including an individual MAC unit 121 and the L9 memory stripe (column) and I/O register element coupled to that MAC unit, is referred to herein as a MAC processor, with the TPU including a total of L such MAC processors implementing a collective parallel MAC pipeline. In some contexts, the MAC units themselves may be referred to (or viewed as) constituting the MAC processors, with the L0 memory and/or shift-out register comprising processor-support circuitry. In any case, broadcast data register 117 outputs a sequence of shared input data values, one per MAC cycle, to all MAC processors such that all MAC processors within the TPU operate on the same broadcast data value during a given multiply-and-accumulate (MAC) cycle.

Still referring to FIG. 1, the various PHYs within inferencing IC 100 include a host I/O PHY 131 (e.g., compliant with a Peripheral Component Interconnect express (PCIe) standard or any other practicable standard or proprietary physical signaling hardware set/control protocol) to enable bidirectional information and/or instruction exchange with respect to a host processor or other control component; a memory-control PHY 133 to support read/write access to a system-level memory installation (e.g., dynamic random access memory (DRAM), flash memory, etc., disposed on a socketed memory module or implemented in any other practicable form factor), and one or more general-purpose I/O PHYs 135, 137 used, for example and without limitation, to coordinate operation between (gang) two or more inferencing ICs in a multi-chip inferencing system (with such multiple inferencing ICs 101 disposed in shared package to form a system-in-package, multi-package IC, three-dimensional IC, etc., or implemented as discrete components and interconnected via printed-circuit-board traces or other wired or wireless signaling media), establish network interconnect (e.g., according to any practicable Internet or intranet (WAN, LAN) physical layer interconnect and/or protocol suite), access nonvolatile storage media, etc. Various additional or alternative PHYs may be implemented within inferencing IC 101 in alternative embodiments, and any practicable higher-layer protocols may be implemented in connection with a given PHY (e.g., Compute Express Link or other memory-semantic protocol implemented over PCIe physical layer installation of host I/O PHY 131; memory control protocols according to various JEDEC standards implemented via memory control PHY 133; etc.). Also, the L3 and L2 memories disposed within (or accessed via) interconnect circuitry 103 may be implemented by various memory technologies in any combination (e.g., DRAM, static random access memory (SRAM), non-volatile memory, etc.) and, like processing-tile-resident L1 memory and TPU-resident L0 memory, are operationally distinguished by storage capacity and access speed/latency, with L0 memory nominally being the smallest, fasted on-chip memory and L3 being the largest (highest capacity), slowest on-chip memory. Additional or fewer memory levels may be implemented within the on-chip memory hierarchy in other embodiments, and the dispositions of individual memory levels may vary in all cases.

Referring again to the exemplary TPU detail view 115 (one of the sixteen TPUs disposed within processing tile 1 and coupled in common to the data output lines of the tile-resident L1 memory 109), each of the L multiply-accumulate units 121 execute parallel tensor processing operations—in effect matrix multiplication operations in which a two dimensional matrix of filter weight values (F_{KL}, where ‘K’ and ‘L’ are the matrix row and column indices) is vector-multiplied with a one dimensional input-data tensor, DK to yield an output tensor Y_{L}. As discussed below, the input data tensor D_{K} generally constitutes a fragment or sub-tensor of a substantially larger input tensor (i.e., with segments of that tensor progressively loaded into processing tiles 101 via hierarchical memory levels (and thus ultimately into broadcast-data storage elements of individual TPUs 107) after retrieval from external memory and/or receipt from the host or data network via the memory PHY/host PHY/GPIO PHY) and output tensor Y_{L} likewise constitutes a fragment or sub-tensor of a substantially larger output tensor. The vector multiplication operation yields, as each component value within the output tensor, a convolution of the filter matrix and input tensor—multiplication of each weighting element within a given column of the filter matrix with a respective input data element within the input tensor to produce K multiplication products which are summed to produce a respective data element within the output tensor. That is: Y_{L}=ΣF_{KL}*D_{K}, for K=0 to maxK, so that Y₀=ΣF_{K0}*D_{K}, Y₁=ΣF_{K1}*D_{K}, . . . , Y_{maxL}=ΣF_{KmaxL}*D_{K}. Accordingly, in a vector multiplication of a filter weight matrix having K*L component values (filter elements or weighting values) with an input data tensor having K data elements, each of L components of the Y_{L} output tensor is produced by performing K multiplication operations and K accumulations of the multiplication products into the tensor output value and thus K multiply-and-accumulate operations pipelined in a sequence of MAC cycles (i.e., generating multiplication product during a given MAC cycle and, during that same MAC cycle, adding product generated during previous MAC cycle into accumulated sum). While an intuitive approach to convolving multiple input data elements and filter elements is to apply all the different data elements simultaneously as operands in parallel multiplication operations (i.e., K simultaneous multiplications with the K different data values in each MAC cycle), such “multi-data” approach requires (i) shifting/rotating of the input data elements (D[K]) relative to partially accumulated output values (Y[L]) following each MAC cycle (i.e., as each of the K input data values is applied in a respective one of the K multiplication operations feeding into a given output value, Y), and (ii) that all K data elements of the input tensor be loaded into respective MAC processors prior to commencement of the initial MAC cycle—a “load phase” that requires K serial shift operations (K MAC cycles where the data load circuitry and MAC processors are timed by the same clock) or a widened input data port (e.g., K*b wide, where ‘b’ is the bit-depth of an individual input data value).

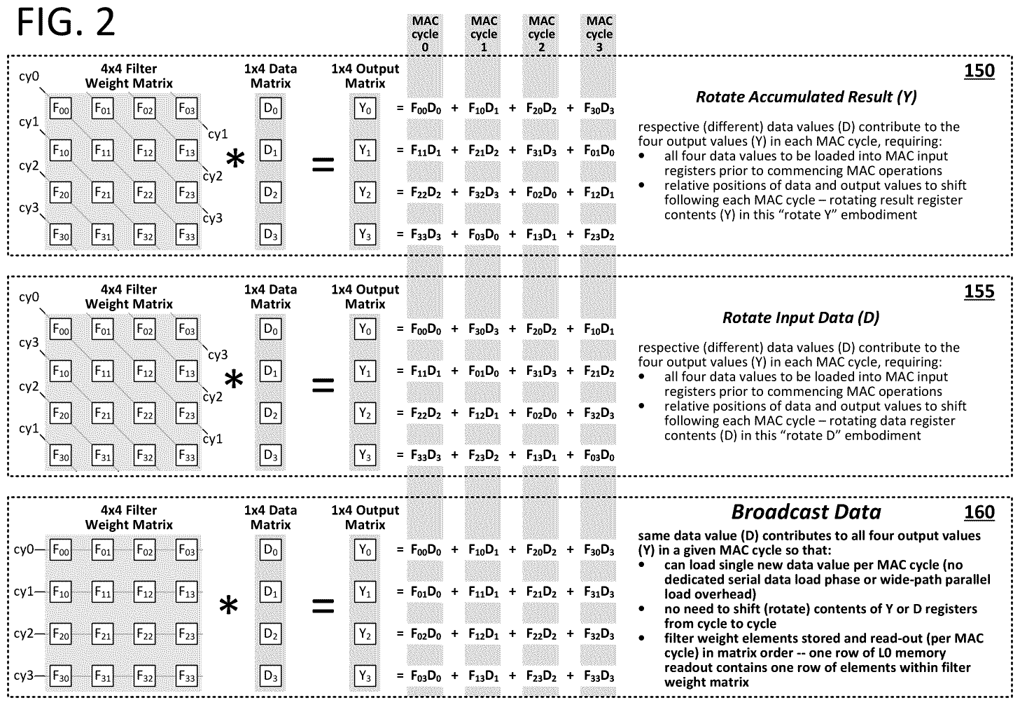

FIG. 2 contrasts the multi-data tensor processing scheme with a broadcast-data tensor processing approach implemented within the TPUs of FIG. 1, showing alternative “rotate result” and “rotate input” instances of the multi-data scheme at 150 and 155, respectively, and the broadcast-data approach at 160—all in the context of an exemplary 4×4 filter weight matrix, 1×4 input-data matrix and 1x4 result matrix (i.e., K=4, L=4). In the rotate-result (or “rotate Y”) and rotate-data examples at 150 and 155, all four of the input data values (D₀, D₁, D₂, D₃) are applied in each of four MAC cycles to yield four result values (Y₀, Y₁, Y₂, Y₃)—each of the four input data values being multiplied with a respective filter weight in each MAC cycle in accordance with the respective filter-weight selections shown by “cy0”, “cy1”, “cy2”, “cy3”. Because all input data values are loaded prior to commencement of multiply-accumulate operations and because all four input data values are applied to yield a given result value, either the input data values or accumulated results are exchanged between the MAC processors following each MAC cycle (i.e., each MAC processor receives either the input data value or the partially accumulated result value from another of the MAC processors) to enable contribution of a new one of the input data values to a given product accumulation—a data exchange implemented, for example, by circular shifting (rotating) of the data values or the partially accumulated result values among the MAC processors. In the result rotation approach at 150, the input data values are maintained within respective MAC processors throughout the vector multiply operation (no input data rotation), with partial accumulation results rotated following each MAC cycle to effect cycle-to-cycle data/result realignment. In addition to the added latency of loading all data values into the MAC processor bank before commencing multiply-accumulate operations (i.e., the multi-data load latency), result rotation tends to shrink operational timing margin as the inter-processor result exchange consumes part of the MAC cycle allocated to add the partially accumulated result and locally generated multiplication product. Moreover, the set of weighting operands applied in any given MAC cycle are drawn from a diagonal slice of the filter weight matrix (i.e., each weighting value applied in a given MAC cycle has both a unique row index and a unique column index relative to all other weighting values applied in that same MAC cycle) complicating filter matrix storage within memory—requiring either (i) matrix elements to be stored in skewed alignment within L2, L1, L0 memories so that the diagonal matrix slices (sets of filter weights aligned along diagonals within the filter weight matrix) may be read out cycle by cycle, or (ii) specialized readout architecture within the L0 memory that effects the diagonal slice (e.g., skewing the address decode to select entries from different L0 memory rows for respective MAC processors).

Still referring to FIG. 2, cycle-to-cycle input data rotation as shown at 155 avoids the timing budget strain of the result rotation scheme (i.e., no same-MAC-cycle application of neighbor-sourced value in an arithmetic operation), but suffers the same multi-data load latency and skewed filter matrix application as the result rotation approach (as the input data values are rotated while the accumulation values remain static in respective MAC processors and the cycle-to-cycle progression through the weighting matrix includes the same diagonally-aligned values in reverse order). The broadcast-data approach by contrast, avoids the multi-data load latency as the same input data value is applied within all MAC processors during a given MAC cycle so that (i) only one shared input data value (broadcast data value) must be loaded into the constituent MAC processors of a given TPU before commencing MAC operations and (ii) each of the K shared input data values may be supplied to the MAC processors in succession over the sequence of K MAC cycles required for the vector matrix multiply—just-in-time data delivery that avoids the extensive pre-load latency of the data exchange architectures (150, 155). The broadcast-data approach also avoids skewed weighting value storage/read-out as the MAC units apply respective weighting values from the same row of the filter weight matrix during each MAC cycle (progressing cycle-by-cycle through all rows of the filter weight matrix). Moreover, because there is no cycle-to-cycle data exchange between the MAC processors (all MAC processors load the same newly broadcast data value (D_{K}) in each MAC cycle), the total number of MAC cycles applied in a given vector multiplication and thus the dimension K of the filter weight matrix (F_{KL}) and input data tensor (D_{K}) is unshackled from (rendered independent of) the number of MAC processors applied in the vector multiplication (the processor count otherwise being constrained/configured to ‘K(’ ensure rotation of K input-data values or K partially accumulated results among K MAC processors). Nor are MAC cycle timing budgets encumbered by data exchange latency (e.g., in contrast to the result-rotation approach in which result exchange and summation operations are executed sequentially in the same MAC cycle).

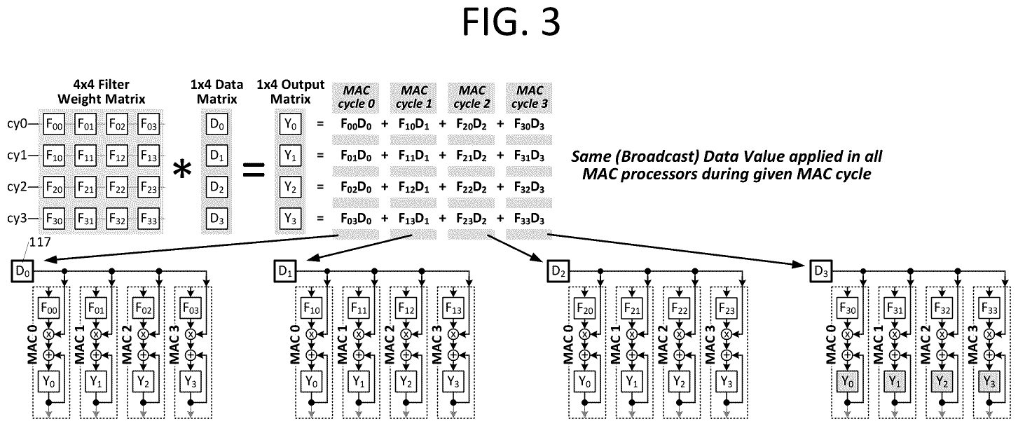

FIG. 3 illustrates an exemplary execution of the FIG. broadcast data example within an exemplary set of four MAC processors (MAC0-MAC3), showing the cycle-by-cycle transition of the input data value and respective rows of the filter weight matrix applied within the MAC processors in each MAC operation. As the same input data value is supplied to (and thus shared by) all four MAC processors during each cycle, vector multiplication commences after loading the first input data value (D0) into processor-shared data register 117 (i.e., broadcast data register)—no need to load all four data values (which in practical application is generally a much higher number—64, 128, 256, 512, etc.—incurring a correspondingly higher latency). Moreover, the filter weights applied in each MAC cycle correspond to a respective row of the 4×4 filter matrix, meaning that the filter weight elements may be stored within MAC processor memory (“L0” memory and higher order memory) in matrix order and thus without the pre-skew required by the data/result-rotation schemes. Further, as there is no input data or result exchange, component values of the output tensor are generated one-for-one within respective MAC processors and without regard to the row dimension (K) of the filter weight matrix and input data matrix, and therefore independently of the number of MAC cycles (and MAC operations) executed to achieve the final output result. For example, the 4-column by 4-row (4×4) filter weight matrix and 1×4 input data matrix may be generalized to a 4×K filter weight matrix and 1×K input data matrix (K being any practicable value, for example, within the data overflow limitation of the hardware set) with each MAC processor executing K MAC cycles to generate the finalized output result (instead of the four MAC cycles shown). By contrast, in a data/result rotation scheme, component 4×4 results must generally be pre-loaded into the MAC processor accumulators (i.e., register elements Y₀-Y₃) following each 4×4 operation, iteratively executing the component 4×4 vector-multiply operation (and partial result pre-load) with respective sets of pre-loaded input values until all K input data values and K rows filter weight values have been convolved.

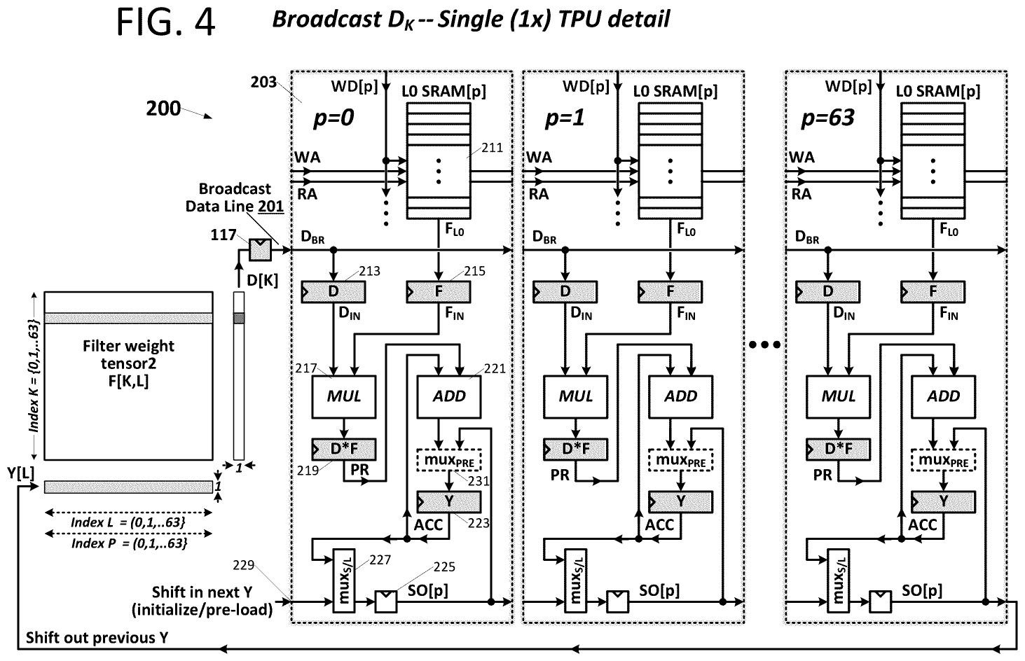

FIG. 4 illustrates a more detailed embodiment of a broadcast-data TPU 200 having a broadcast data register 117 that drives, via broadcast data line 201, a shared input data value (D[K]) to each of 64 MAC processors 203 (i.e., processor index ‘p’ ranges from 0 to 63 and, in this example, matches the number of components ‘L’ of output tensor Y_{L}). In the depicted implementation, each of the MAC processors includes an L0 SRAM stripe 211 (e.g., to store K filter weight operands to be multiplied, within a given MAC processor, with the K sequentially broadcast data values in K respective MAC cycles), a data operand register 213, weight operand register 215, multiplier circuit 217, product register 219, adder circuit 221 and accumulated-result register 223 (referred to herein as the “result” register for brevity). As shown, the L0 memory stripes (i.e., L0 SRAM[p]) within the 64 MAC processors—collectively forming the TPU L0 memory—receive a shared set of read and write address signals, RA and WA, the former (RA) to select filter weight operands (F_{L0}) output from the per-processor L0 memory stripes 211 to the weight operand registers 215 of respective MAC processors 203, and the latter (WA) to enable unloaded filter weight operands (i.e., operands already output to weight operand registers 215) to be overwritten with inbound operand values (i.e., arriving via per-processor write data lines WD[p]) to be applied in subsequent vector multiplication operations. In a number of embodiments, the collective L0 memory formed by per-processor stripes 211 (which may be implemented by register files, SRAM arrays, or any other practicable small-footprint memory) is dual ported to enable simultaneous read and write operations, with read/write control logic (e.g., implemented within TPU 200 though not specifically shown) to sequence the read and write addresses through respective modulo counts (i.e., from zero to K, and then back to zero—with the write address lagging one or more entries behind the read address) and also to output control signals as necessary to time read and write address decoding operations, etc. In other embodiments, the LO memory may include two banks of single-ported storage elements, with one bank serving as the operand readout source during a given vector multiply interval while the other bank is loaded (during that same vector multiply interval) with filter weight operands to be applied in a subsequent vector multiply interval, the two banks switching roles at commencement of that subsequent vector multiply interval.

In the FIG. 4 embodiment, broadcast data register 117, per-processor operand registers (213, 215), per-processor product registers 219 and per-processor result registers 223 are clocked/synchronized by a shared clock signal (or respective clock-tree-generated instances of two or more same-phase clock signals) to implement pipelined data broadcast, operand load, product load, and product accumulation operations—operations executed in respective stages of a MAC pipeline with each stage of execution (“pipestage”) with regard to a given input data value transpiring in a respective clock cycle, referred to herein as a “MAC” cycle. More specifically, an input data value is clocked into the processor-shared broadcast data register 117 in a broadcast data load pipestage, and then into the data operand register 213 during an ensuing operand load pipestage (in which a corresponding weighing operand is loaded from LO memory into weighting operand register 215). The operand load pipestage is followed by a product load pipestage in which a multiplication product generated by multiplier 217 (i.e., combinatorial logic to multiplying the operands output from registers 213 and 215) is loaded into product register 219. The product load pipestage is followed in turn by a result load pipestage—loading the output of adder 221 (i.e., combinatorial logic to add the multiplication product from product register 219 and the product accumulation (if any) previously loaded into result register 223) into result register 223, thus accumulating a sum of cyclically generated multiplication products within result register 223.

At the conclusion of a vector multiply operation, the output tensor (accumulated within collective result registers 223 of the MAC processors) is transferred from the result registers to a bank of shift-out registers 225 via shift/load multiplexer 227—one such shift-out register 225 per MAC processor 203 in the depicted embodiment—freeing the result registers 223 for a subsequent vector multiply operation. As shown, the shift-out registers 225 are coupled to one another (via ports within shift/load multiplexers 227) to form a shift register or queue such that, during respective MAC cycles of the subsequent vector multiply operation, the contents of shift-out registers 225 (i.e., output tensor) may be shifted out, tensor component by tensor component, to downstream circuitry (e.g., to shift-in input 229 of another TPU via NLINK/NOC interconnect circuitry) and/or for storage within on-chip (L2, L3) or external memory. An optional pre-load multiplexer 231 is imposed between adder 221 and result register 223 of each MAC processor to enable content shifted into the shift-out register bank to be parallel-loaded (i.e., transferred in parallel) into result registers 223, thus effecting a data pre-load (e.g., partially accumulated output tensor where a given vector multiply is split into component operations executed over respective sets of MAC sequences/cycles). Though not specifically shown, a finite state machine, sequencer or other control circuitry may be implemented within each TPU (or shared among multiple TPUs) to issue various control/configuration signals to the multiplier 217, adder 221, shift/load multiplexer 227, and pre-load multiplexer 227 within each of the MAC processors and/or other TPU components (e.g., inter-TPU adder circuitry, TPU interconnect circuitry, etc.), for example, to control multiplexer operation, enable multiplication/summation operations with various data formats (floating point, fixed point, etc. all with various precision/bit-depth, etc.), override (e.g., forcing to zero) the result-register input to adder 221 to reset the accumulated result during the first product accumulation within a vector multiply operation, and so forth.

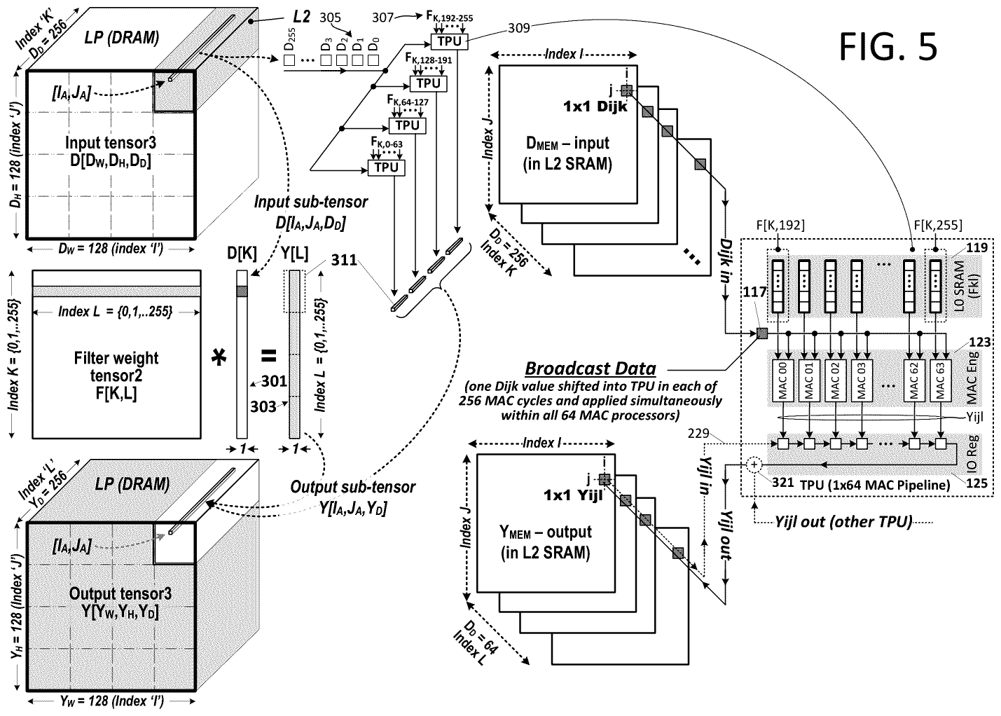

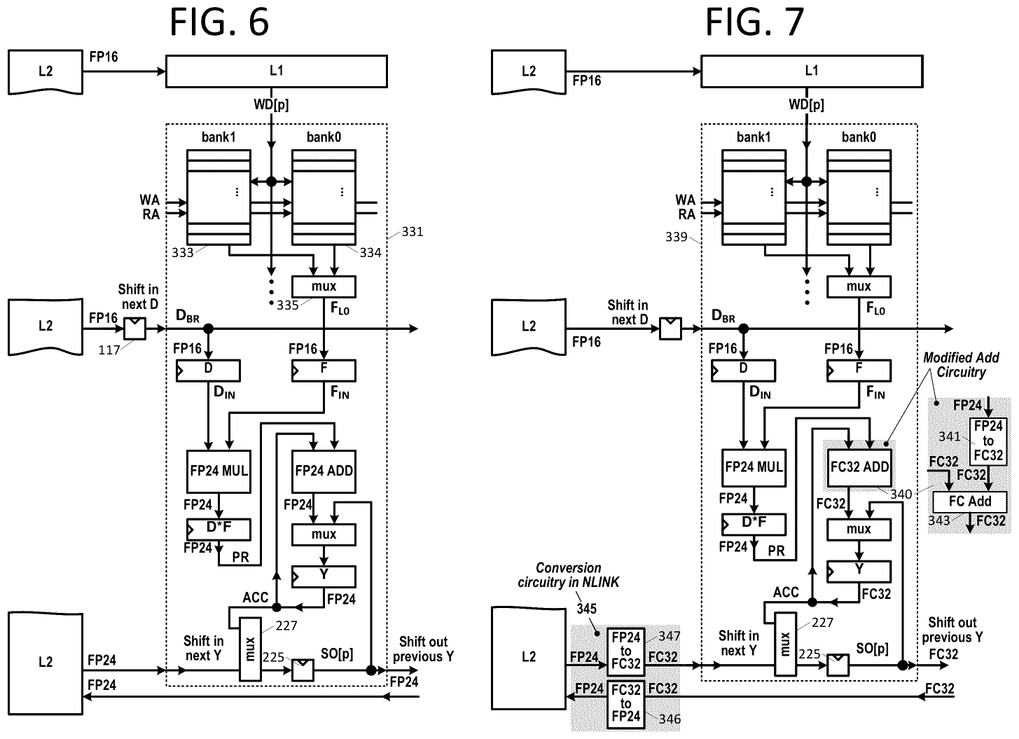

FIG. 5 presents exemplary tensor processing executed within the broadcast-data TPUs of FIG. 1. In the depicted example, an input data tensor3 the ‘3’ suffix indicating a three-dimensional tensor) having a 128×128 array of input sub-tensors 301, each 256 data elements deep (K=256 such that the total number of input tensor3 data elements is 2⁷*2⁷*2⁸=2²² n-bit data elements) is convolved with a two-dimensional 256×256 filter weight matrix tensor (i.e., filter weight tensor2) to produce an output data tensor3 having a 128×128 array of 256-element output sub-tensors 303. As each broadcast-data TPU includes 64 parallel MAC processors in this instance, and each of the 256 input data values of a given input sub-tensor is to be multiplied by a respective set of 256 filter weights (i.e., a respective one of K rows of filter weight tensor2), the sub-tensor processing operation is executed in the FIG. 6 example by sequentially shifting each of the 256 input data values (constituents of input sub-tensor 301) in parallel into respective broadcast data registers of four broadcast-data TPUs as shown at 305. The L0 memories within the TPU quartet are loaded with respective column-stripes of the tensor2 filter weights such that, for example, the first of the four TPUs is loaded with the filter weights from columns 0-63 of filter weight tensor2, the second of the four TPUs is loaded with filter weights from tensor2 columns 64-127, the third TPU of the quartet is loaded filter weights from tensor2 columns 128-191, and the last of the four TPUs is loaded with filter weights from tensor2 columns 192-255 (i.e., as shown generally at 307 and in the exemplary TPU detail at 309). Accordingly, as the data input index ‘k’ advances from 0 to 255 (more generally, from 0 to K−1), the read address applied within the L0 memories of the TPU quartet (four broadcast data TPUs) allocated to process input sub-tensor 301 is likewise advanced from 0 to 255 so that each TPU of the quartet generates a respective one-fourth fragment 311 of output sub-tensor 303, with the four fragments being shifted out of the quartet TPUs in parallel for storage (as sub-tensor 303) within memory allocated for output data tensor3.

Still referring to FIG. 5, exemplary input and output data flow within each TPU of the sub-tensor processing quartet is shown in detail view 309. As shown, each of 256 input data values is loaded, MAC cycle by MAC cycle, into the broadcast data register 117 of the TPU and thus applied simultaneously within all 64 multiply-accumulate units within MAC engine 123 (each MAC unit receiving a respective sequence of 64 filter weights from L0 memory 119), yielding a quarter-fragment of the output sub-tensor after 256 MAC cycles (i.e., fragment containing 64 of 256 component values of the output sub-tensor), shifting that sub-tensor fragment out of the TPU via shift-out register (I/O register) 125 during execution of an ensuing input sub-tensor processing interval (ensuing 64-MAC-cycle interval). Note that summation circuitry 321 may be provided (e.g., within the NLINK component of a given TPU—shown for example at 127 in FIG. 1) to sum the sub-tensor output with that of another TPU, thus providing flexibility for alternative TPU groupings (and thus alternative parallel processing arrangements) within the FIG. 1 inferencing IC. The output of a given TPU (or other TPU) may also or alternatively be pre-loaded into a given TPU (e.g., via pre-load multiplexers as shown at 223 in FIG. 4) to enable a partial accumulation result to be re-applied in a subsequent MAC processing sequence. With regard to pre-loading, for example, where input data dimension K for a given sub-tensor processing exceeds practical limitations (e.g., product or accumulated-result register bit depths, L0 memory row count, etc.), sub-tensor processing may be segmented into n successive operational sub-intervals, accumulating partial results with respect to K/n input data values and K/n rows of filter weight values in each operational sub-interval. The partial results generated by a given TPU during an operational sub-interval may be stored within memory (e.g., L2 and/or L3 memory) and then later pre-loaded into the same or a different TPU via the shift-in path (e.g., as shown at 229 in FIGS. 4 and 6) to enable continued result accumulation with respect to another of the K/n input data values (and another of the K/n rows of filter weight values).

Continuing with FIG. 5 and assuming the exemplary number of broadcast-data TPUs shown in FIG. 1 (i.e., eight tiles within inferencing IC 100, each tile including 16 broadcast-data TPUs and thus 128 broadcast-data TPUs), each of 32 TPU quartets is capable of processing a respective one of 32 input sub-tensors (generating a corresponding one of 32 output sub-tensors) per vector multiplication interval (i.e., complete MAC pipeline execution spanning 256 MAC cycles in the K=256 example of FIG. 6), and thus processing each of the 16,384 input sub-tensors that constitute input data tensor3 (i.e., 128×128 sub-tensors) over 512 successive vector multiplication intervals to yield the corresponding 16,384 output sub-tensors that constitute output data tensor3. In one embodiment, each of the 256 MAC cycles within a given vector multiplication interval corresponds to the cycle time of a 16 GHz clock signal (i.e., MAC cycle time=clock cycle time, t_{CLK}), so the total time required for inferencing IC 100 to convolve the four million+ (i.e., 2²²) input tensor data values with the 65 thousand+ (2¹⁶) filter weight matrix is 2⁹*2⁸ MAC cycles/2⁴*10⁹ MAC cycles/second=(2¹³/10⁹) seconds and thus approximately 8 microseconds. Said another way, inferencing IC 100 can perform 160,000 such tensor processing operations per second (yielding a respective output data tensor3 in each operation) and thus at a rate that enables real-time inferencing with respect to massive amounts of input data (e.g., high resolution and/or high frame rate video and possibly multiple video streams) in a single integrated circuit component—enabling IC 100 to be deployed within edge-of-network/Internet devices alone or together with other such inferencing ICs (coordinating with one another via the host PHY or via general purpose IO PHYs shown in FIG. 1) to implement real-time, in-situ inferencing.

FIG. 6 illustrates exemplary numerical precision of data at various ingress/egress and internal points within a MAC processor 331 implemented generally as discussed above, but having two L0 memory banks (333, 334) to enable one bank to be written concurrently with filter weight readout from the other (with those roles reversed via multiplexer 335 after every vector multiply interval). Incoming image data (input pixel values) are obtained from an L2 memory in either FP16 (16-bit floating point) or FP24 (24-bit floating point) format, in the latter case being converted on-the-fly into FP16 format. The FP16 data values are shifted into a broadcast data register 117 as discussed above, and thereafter parallel-loaded into respective data registers (“D”) for all MAC processors (only one such processor being shown). Input filter weight values are parallel-loaded into the filter weight registers “F” of all MAC processors from one of the L0 memory banks (such values having been previously loaded from L2 memory to L1 memory, and then from L1 memory into the subject L0 memory bank with, for example, on-the-fly conversion from FP8 to FP16 format in the transfer from L2 to L1). Within the multiply-accumulate unit, multiplier circuit (“FP24 MUL”) multiplies the FP16-format data and filter weight values to yield a FP24 (24-bit floating point format) product, with that product added to prior multiplication products within accumulator “FP24 Add” to yield—i.e., load into result register “Y”—a sum of products with FP24 precision. In an exemplary 64-cycle vector-multiply interval, after 64 products have been accumulated within each “Y” result register, the accumulation results are parallel-loaded into MAC shift-out registers 225 (only one being shown) to be serially shifted out with FP24 precision during the subsequent vector multiply interval. Where partial vector-multiply results are to be pre-loaded within the result registers, FP24 partial accumulation values may be shifted into registers 225 (i.e., via multiplexer 227) as (or after) the current FP24 accumulation results are shifted out.

FIG. 7 illustrates an alternative TPU embodiment having MAC processors (single instance shown at 339) that reduce area and power consumption by using a “coarse” floating point format for accumulated multiplication products—an alternate numeric format that remaps the exponent and fractional fields of a standard floating point format as discussed below to avoid pre-summation operand alignment and post-summation result normalization overhead, obviating the full-width left and right operand-field shift circuitry and deep multiplexing trees (for steering intermediate values for various operand cases) generally required by conventional floating-point summation circuits. Inbound data and filter weight values have the same formats as in the FIG. 6 example (including optional on-the-fly conversion in the progression from more remote/larger memory), and the floating-point multiplier yields a same-format (FP24) product. By contrast, adder circuitry 340 is modified (relative to the FP24 adder in FIG. 6) to accumulate iteratively generated FP24 products into a 32-bit coarse floating point (FC32) result. In the depicted implementation, for example, the stream of incoming multiplication products is format-converted (one product per MAC cycle) from FP24 to FC32 within converters 341, and then added within coarse floating point adder 343 to produce an FC32 accumulation result. Assuming the same 64-cycle vector-multiply interval as in the FIG. 6 example, after 64 FC32 products have been accumulated with respective result registers “Y” (i.e., result registers within respective MAC processors), the accumulation results are parallel-loaded into MAC shift-out registers 225 (only one being shown) to be serially shifted out with FC32 precision during the subsequent vector multiply interval. As in the FIG. 6 embodiment, where partial vector-multiply results are to be pre-loaded within the “Y” result registers, FC32 partial accumulation values may be shifted in as (or after) the current FC32 accumulation results are shifted out.

In the FIG. 7 embodiment, format conversion circuitry 345 is provided within the per-TPU NLINK circuitry to convert between FC32 and FP24 formats. More specifically, outbound FC32 values are converted one after another to FP24-format result values within FC32-to-FP24 converter 346 while inbound FP24 values (e.g., partial accumulation results to be pre-loaded into the MAC-processor result registers) are converted one after another to FC32 values within FP24-to-FC32 converter 347. The depicted data formats in FIG. 7 and elsewhere herein may have different precisions in alternative embodiments and/or programmable configurations (e.g., FP24 values may instead be FP32 values such that NLINK circuits 346 and 347 convert between FP32 and FC32, FP16 values may instead be FP24 values, etc.).

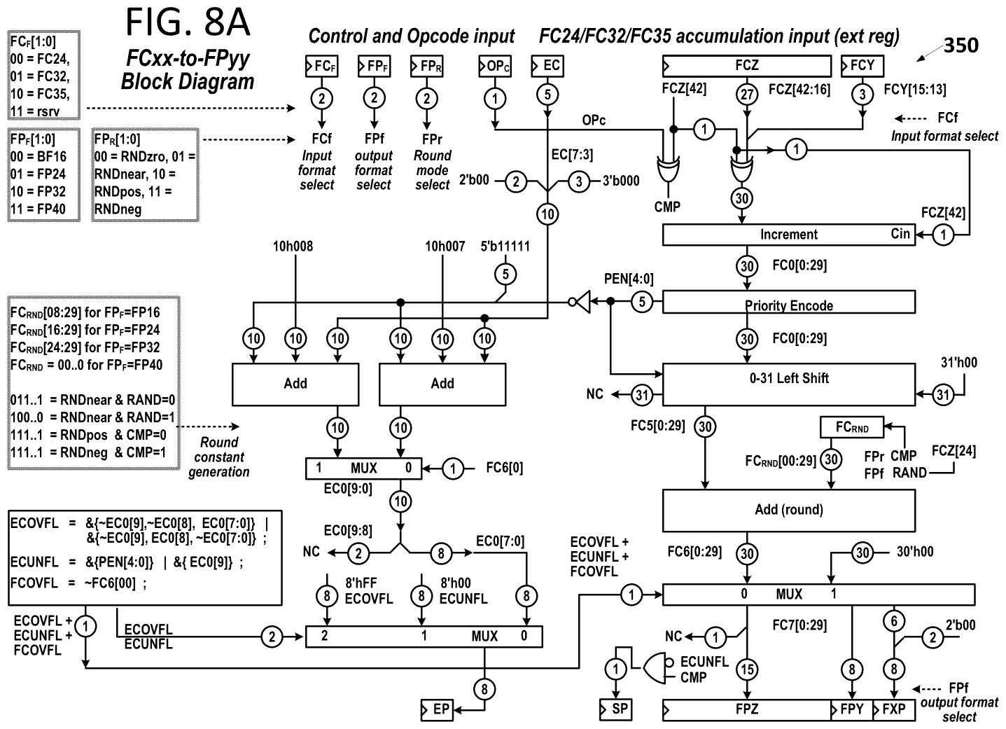

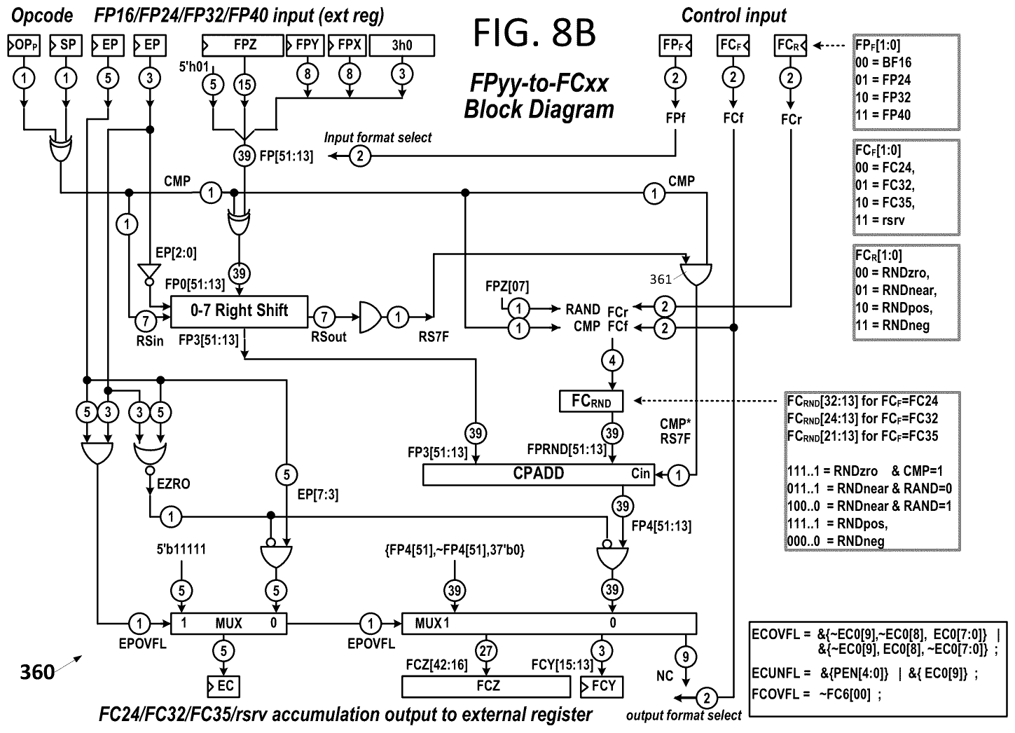

FIG. 8A illustrates an embodiment of a logic circuit 350 that may be deployed within the MAC-processor shift-out path (i.e., within the per-TPU NLINK block) to convert from coarse floating-point (FC) values to standard floating-point (FP) values (e.g., to implement circuit block 346 in FIG. 7). In the depicted example, the FC-to-FP conversion is implemented by combinational logic circuitry disposed between source and destination registers (i.e., in a single pipeline stage)—receiving FC input values from source registers during a given MAC cycle (e.g., registers outside FIG. 7 conversion circuitry 345) and converting those input values into corresponding FP values that are loaded into a set of destination registers at the clock edge that commences the subsequent MAC cycle. The exemplary FC input value includes several fields: EC[7:3] is a 5-bit exponent field, and {FCZ[42:16], FCY[15:13]} is a 30 bit fraction field. The fraction field uses a two's complement numeric format, with FCZ[42] being the sign bit. The FCf[1:0] control input—a configuration value programmed within a configuration register of the host IC (i.e., programmable configuration value)—selects one of three FCxx formats (FC24, FC32, and FC35) for the input operand. The OPc control input (another programmable configuration value) optionally negates the FPyy output result. Programmable configuration value FPr[1:0] selects one of four rounding modes (RNDzero, RNDnear, RNDpos, and RNDneg) for the output result, and programmable configuration value FPf[1:0] control input selects one of four FP formats (BF16/FP16, FP24, FP32, and FP40) for the output precision. The conversion process begins by inserting the 30-bit input fraction {FCZ[42:16], FPY[15:13]} into the 30-bit internal path, with the FCZ[42] sign bit conditionally complementing and incrementing the {FCZ[42:16], FPY[15:13]} fraction to drive the FC0[00:29] bus (e.g., with a positive magnitude value). The FC0[0:29] 30-bit internal bus is passed to the priority-encode block, while a 5-bit priority-encoded output (PEN[4:0]) indicates the bit-position of the upper-most one bit. A PEN[4:0] value of 5′b11111, for example, indicates FC0[0:29] is 30′h00000000. The PEN[4:0] value is also used to specify bit-shifting with respect to values passing from the FC0 to the FC5 busses, causing the value on the FC0[0:29] bus to be shifted left upon transfer to the FC5[0:29] bus. The shift-input bits are zero, and the shift-out bits are not significant and are discarded.

In the FIG. 8A embodiment, a rounding constant FCRND[00:29] is generated with four different fields of bits set to non-zero values, depending upon the FPf[1:0] control input. In the depicted example, the FP16/BF16 non-zero field is FCRND[08:29], the FP24 non-zero field is FCRND[16:29], the FP32 non-zero field is FCRND[24:29], and the FP40 non-zero field is null (the bits to the left of these fields are set to zero). The non-zero field is set to one of several values, depending upon the programmable FPr[1:0] rounding mode control input. In the embodiment shown, the RNDzro value is always 000 . . . 0, the RNDnear value is 011 . . . 1 (if RAND=0) or 100 . . . 0 (if RAND=1), the RNDpos value is 111 . . . 1 (CMP=0) or 000 . . . 0 (CMP=1), and the RNDneg value is 111 . . . 1 (CMP=1) or 000 . . . 0 (CMP=0). The RAND signal is a pseudo-random signal (FCZ[24]) that ensures that the rounding direction for positive and negative values is symmetrical. The bit-shifted value conveyed on bus FC5[0:29] is added to the rounding constant on bus FCRND[00:29] (with carry-in equal to zero) to drive a resultant value on the FC6[0:29] bus.

Still referring to FIG. 8A, exponent field EC[2:0] is set to 3′b000 and PEN[4:0] is subtracted from EC[7:0] to produce ECO[7:0]. A bias constant is also added and the result is incremented if the FC6[0] value is zero (a condition indicating that the fraction rounding caused a fraction overflow FCOVFL). The depicted embodiment includes two exponent adders (so that the exponent addition is not in the critical timing path) with each exponent adder having two addition bits to enable overflow (EOVFL) and underflow (EUNFL) detection. The complete exponent field EC0[9:0] is also checked for special values. For example, the EC0[9:0] value of 10′h0FF or 10′h100 indicates an overflow with an exponent value of 8′hFF (the ECOVFL signal is asserted), while the ECO[9:0] value of 10′b1000000000 or a PEN[4:0] value of 5′b11111 indicates an underflow with an exponent value of 8′h00 (the ECUNFL signal is asserted). Note that this EOVFL and EUNFL detection logic may also be duplicated and multiplexed by the FC6[0] to further reduce the pipeline delay by a few additional logic gates—a timing optimization not specifically shown in the FIG. 8A circuit example. In the depicted embodiment, the FC6[0:29] fraction value is replaced by a zero value (0000 . . . 00) if ECOVFL, ECUNFL, or FOVFL is asserted. Also, the final fraction value is masked to the final output {FPZ[1:15], FPY[16:23, FPY[24:31]} according to the programmable FPf[1:0] configuration value conveyed via the control input select bus. Note that C7[00/FPZ[00]] is a hidden bit and not passed to the output port (it is a logic HIGH for a normalized result and is not used for the EOVFL and EUNFL cases) in the depicted example. The finalized floating-point accumulation output (i.e., having format FP16, FP24, FP32, FP40, etc. according to output-format-select value FPf) is output to an external register, not specifically shown.

FIG. 8B illustrates an embodiment of a logic circuit 360 that may be deployed within the MAC-processor shift-in path (e.g., to implement converter circuit 347 of FIG. 7) and within the FC accumulator circuit (e.g., element 340 of FIG. 7) to convert from standard floating-point (FP) values to coarse floating-point (FC) values. As with the FC-to-FP converter example shown in FIG. 8A, the FP-to-FC conversion is implemented by combinational logic circuitry disposed between source and destination registers (i.e., in a single pipeline stage)—receiving FP input values from source registers during a given MAC cycle (e.g., registers outside FIG. 7 conversion circuitry 346 and FC accumulator 340) and converting those input values into corresponding FC values that are loaded into a set of destination registers at the clock edge that commences the subsequent MAC cycle. Within FC accumulator 340 (at least), additional operations may be carried out (e.g., FC summation operation) within the conversion pipeline so that FP-to-FC conversion and summation of the resulting FC multiplication product with the accumulated FC value (generated during a prior MAC cycle and supplied by result register “Y”) are completed within a single MAC cycle.

Continuing with the FIG. 8B example, the multi-field FP input value includes a sign bit (SP), an 8-bit exponent field (EP[7:0]), and a 31-bit fraction field (FPZ[01:15], FPY[16:23],FPX[24:31]). Various programmable configuration values (control inputs) select the format/precision of the FP input and FC output, selectively negate the FP input and select the rounding mode. In the specific example shown, control input FPf[1:0] selects one of four FP formats (FP16, FP24, FP32, and FP40), control input OPp conditionally complements the SP sign bit to selectively assert a complement signal (CMP) signal that negates the sign-magnitude input FP value, control input FCr[1:0] selects one of four rounding modes (RNDzero, RNDnear, RNDpos, and RNDneg) for the FC output result, and control input FCf[1:0] selects one of three FC formats (FC24, FC32, and FC35) for the output precision. The FP-to-FC conversion process begins by inserting the 31-bit input fraction {FPZ[01:15], FPY[16:23],FPX[24:31]} into the 39-bit internal bus FP[51:13], filling the upper five bits with “5′b00001” and the lower three bits with “3′b000” and then selectively complementing the resulting 39-bit value (on the internal bus) according to the state of the CMP signal to yield an output on the FP0[51:13] bus.

Still referring to FIG. 8B, the three least-significant bits of the exponent field (EP[2:0]) selectively right-shift the value on bus FP0[51:13] (i.e., shifting right by 0 to 7 bits), outputting the resulting value onto the FP3[51:13] bus. The shift-in bits are copies of the CMP signal, while the shift-out bits are checked for all-ones (RS7F=1) so as to selectively enable the CMP signal (i.e., via AND gate 361) to be applied at the carry-in (Cin) of the rounding adder (CPADD). The complete exponent field EP[7:0] is checked for special values, asserting exponent-overflow signal (EPOVFL) in response to an EP[7:0] value of 8′hFF, and asserting an exponent-zero signal (EZRO) in response to an EP[7:0] value of 8′h00.

One of three differently-sized sub-fields of rounding constant FPRND[51:13] is selected in accordance with the coarse floating point precision specified by control input FCf[1:0] and set to one of several non-zero values according to the rounding mode control input (FCr[1:0]), complement signal (CMP) and/or randomizing signal (RAND), the latter being a pseudo-random signal that ensures symmetrical rounding for positive and negative values. In one embodiment, the subject sub-fields (i.e., sub-field set to non-zero value) are FPRND[32:13] if FCf[1:0] specifies format FC24, FPRND[24:13] if FCf[1:0] specifies FC32, and FPRND[21:13] if FCf[1:0] specifies FC35, with all bits to the left of the FCf-specified field set to zero. In the depicted example, the FPRND sub-field is set as follows: all ‘1’s if FC R [1:0] specifies round-to-zero (RNDzro) and CMP=1; all ‘0’s if FC_{R}[1:0] specifies round-to-zero (RNDzro) and CMP=0; ‘011 . . . 1’ if FC_{R}[1:0] specifies round-to-nearest (RNDnear) and RAND=0; ‘100 . . . 0’ if FC_{R}[1:0] specifies round-to-nearest (RNDnear) and RAND=1; ‘111 . . . 1’ if FC_{R}[1:0] specifies round-positive (RNDpos); and ‘000 . . . 0’ if FC R [1:0] specifies round-negative (RNDneg). After the FCf-specified sub-field has been set, rounding constant FPRND[51:13] is added to the shifted input operand FP3[51:13], with the carry-in generated by the CMP signal to produce a rounded fraction value, FP4[51:13]. The FP4[51:13] fraction value is replaced by an overflow value (0100 . .. 00 or 100 . . . 00) if EPOVFL is asserted, or by the zero value (00 . . .00) if EZRO is asserted. The final fraction value is masked to the final output {FCZ[42:16], FCY[15:13]} according to the FCf[1:0] value of the control input select bus. The least-significant nine bits of the fraction value are discarded. The EP[7:3] exponent value is replaced by an overflow value (11111) if EPOVFL is asserted, or by the zero value (00000) if EZRO is asserted, but otherwise constitutes the output exponent.

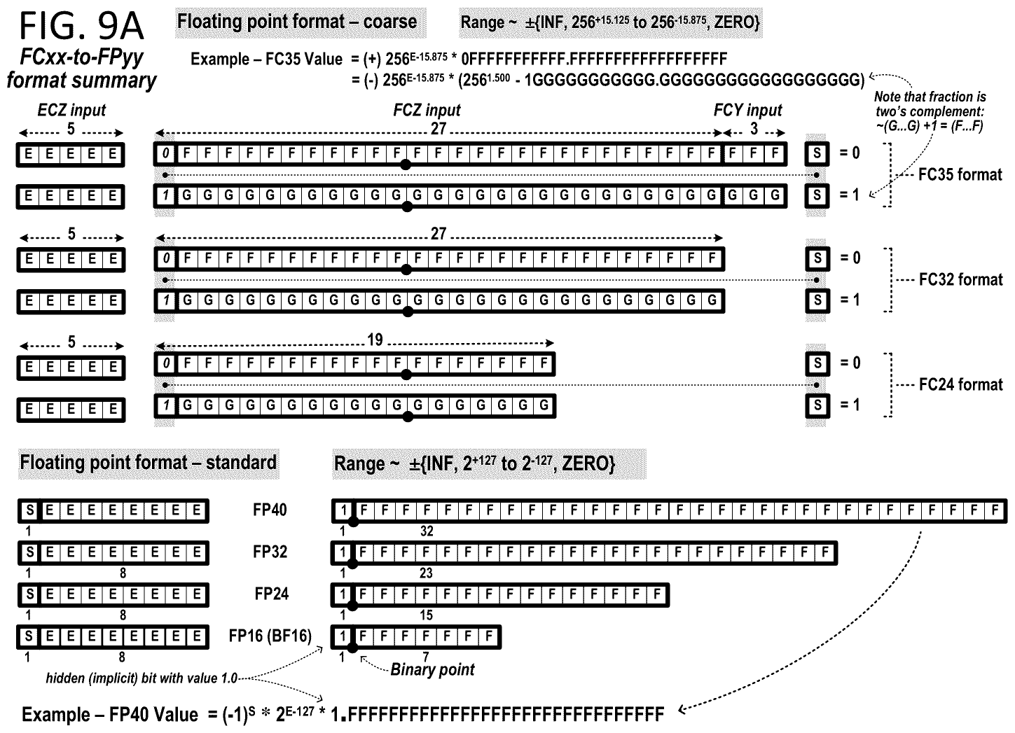

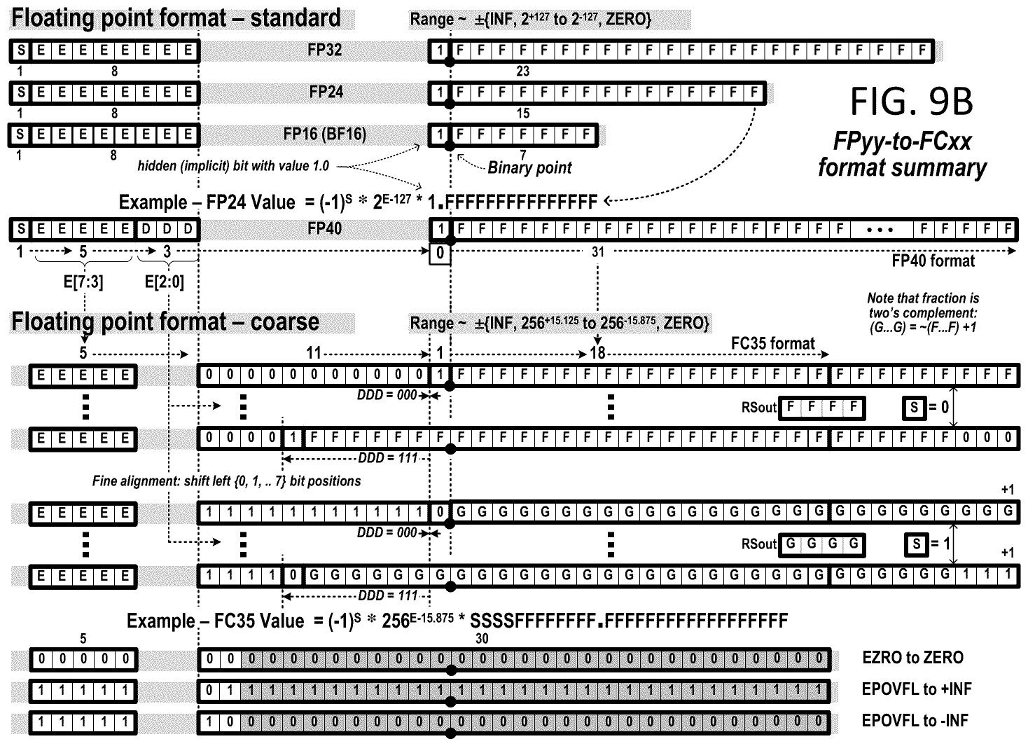

FIG. 9A illustrates exemplary numerical details of the FC and FP floating point formats discussed/illustrated above with respect to FC-to-FP conversion. Three standard formats (FC24, FC32, FC35) are shown (for reference) at the top. Each has a 5-bit exponent field, and a {19,27,30}-bit fraction field. Note that the fraction field uses two's complement numeric format and is not normalized. The four standard formats (FP16/BF16, FP24, FP32, FP40) are shown (for reference) at the bottom. Each has a 1-bit sign field, an 8-bit exponent field, and a {7,15,23,31}-bit fraction field. There is an implicit bit of weight “1.0” added to each fraction (the format is normalized).

FIG. 9B illustrates exemplary numerical details of the FC and FP floating point formats discussed/illustrated above with respect to FP-to-FC conversion and FC addition/accumulation. Four standard formats (FP16/BF16, FP24, FP32, FP40) are shown (for reference) at the top. Each has a 1-bit sign field, an 8-bit exponent field, and a {7,15,23,31}-bit fraction field, with an implicit bit of weight “1.0” added to each fraction (the FP format is normalized, in contrast to the non-normalized FC format). As shown, the FP40 format includes a fraction field (ranging from 1.0 to 1.9999 in the normalized FP format) and an exponent field separated into upper and lower sub-fields, E[7:3] and E[2:0]. The FP40 fraction is right-shifted by the complement of the lower exponent sub-field EP[2:0] in a “fine alignment” operation (implemented by a relatively small-footprint logic circuit)—an operation equivalent to left-shifting by the lower exponent sub-field, EP[2:0], as is shown in the first set of coarse floating-point (FC) formats for which the sign bit is positive (S=0). The fraction is extended to 39-bits and conditionally complemented—i.e., complemented if the sign bit indicates a negative value as shown in the FC formats for which S=1. If the accumulation exponent register EZ[7:3] increments to a maximum threshold, it will be set to the exponent overflow value, as shown in the final two FC formats at the bottom of FIG. 9B. The two values represent positive infinity and negative infinity—these are the saturating overflow values that are also used in the standard floating point formats. Note that there is also room to add NAN (not-a-number) encodings to the INF formats—an option implemented or programmably enabled in selected embodiments. If the accumulation exponent register EZ[7:3] decrements to a minimum threshold, it will be set to the exponent underflow value (zero)—this is the non-saturating underflow value that is also used in the standard floating point formats.

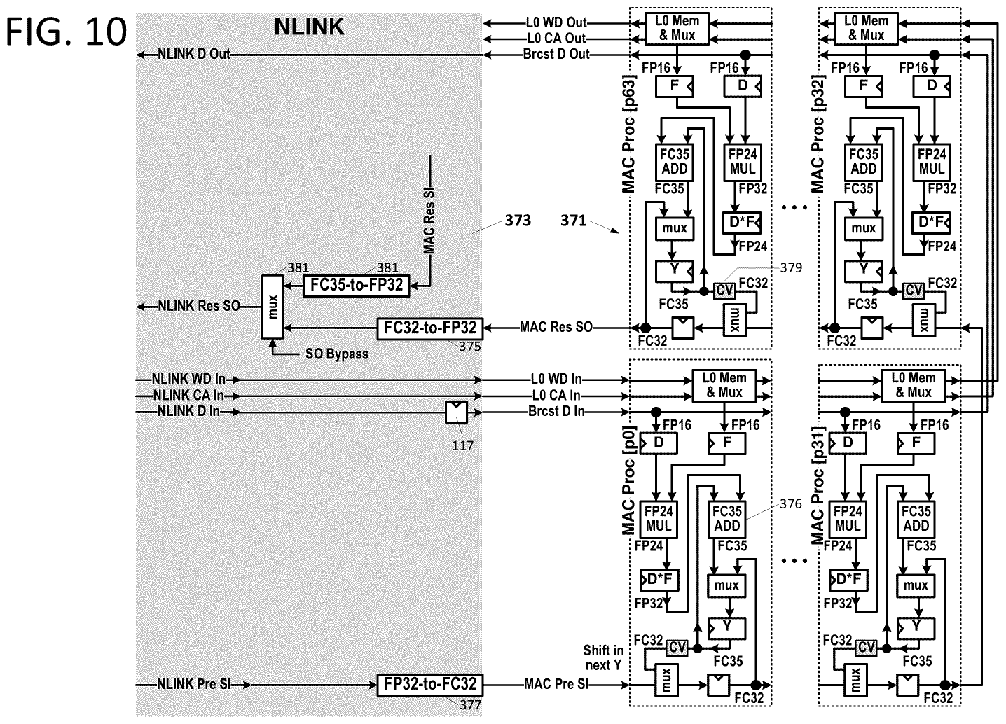

FIG. 10 illustrates an embodiment of a TPU (i.e., that may be deployed within the FIG. 1 inferencing engine) having an exemplary set of 64 broadcast-data MAC processors 371 (i.e., coupled to form a MAC processing pipeline) and NLINK circuitry 373, the latter including programmatically configurable FC-to-FP and FP-to-FC conversion blocks (375 and 377, respectively). In the depicted example, FC-to-FP converter 375 performs an FC32 to FP32 conversion at the output of the multiply-accumulate processing pipeline (i.e., at the output of a final one of the 64 MAC processors in this example). More specifically, the MAC processors 371 generate an array of “N” accumulation totals in FC35 format within respective coarse-floating point adders 376—accumulation totals that are converted to FC32 format by per-processor conversion circuits 379 and then shifted out of the MAC processor array to L2 memory. FC-to-FP converter 375 is disposed in the shift-out path (e.g., within the per-TPU NLINK block 373) and performs on-the-fly conversion from FC32 format to FP32 format. Counterpart converter 377 converts a pre-load stream of partial MAC results (i.e., to be pre-loaded into accumulator circuits of respective MAC processors) from FP32 to FC32. The two converters may alternatively convert between FC32 and FP24 formats (or between FC32 and FP16/BF16 formats) to reduce the L2 memory footprint—options programmatically configured with the FCf, FPf, and FPr control inputs to the converter blocks (e.g., control inputs as discussed in reference to FIG. 9—output, for example, from a shift register loaded from a configuration bus during system initialization and/or during system run time prior to a particular computation operation).

Still referring to FIG. 10, a bypass FC-to-FP converter 381 may be implemented as part of a floating-point add processing element in the NLINK block to perform an FC35 to FP32 conversion with respect to a multiply-accumulate result delivered, for example, from another TPU. In the depicted example, multiplexer 383 is provided to select one of the two MAC-result streams (generated within TPU-resident MAC processors or shifted-in from other TPU) to be output as the final multiply-accumulate result in accordance with a programmable bypass-control value. Note that various additional multiplexers, control signals, input and output signal-line interconnects and so forth may be provided within NLINK circuit block 373, for example, to support connections to NLINK circuit blocks, MAC processing pipelines etc. within other TPUs and/or to on-chip or off-chip memory (i.e., to L2, L3 memory, to network-on-chip circuitry and its interconnection to various PHYs as shown, for example, in FIG. 1).

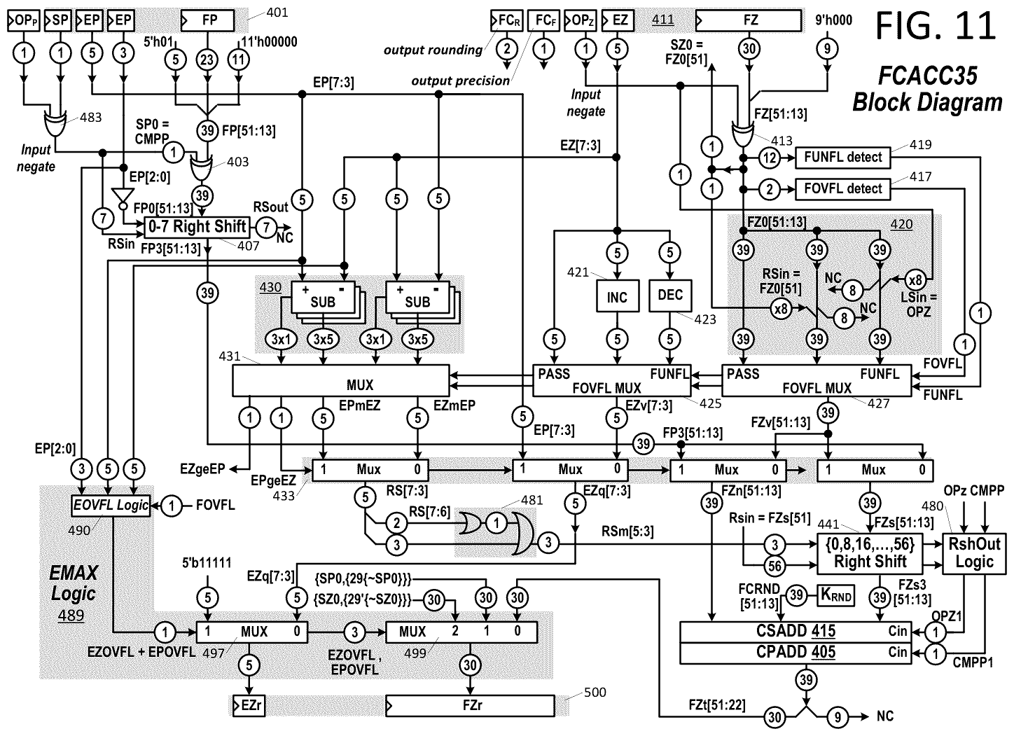

FIG. 11 illustrates a more detailed embodiment of the coarse floating-point adder/accumulator shown at 376 in FIG. 10—a circuit block that avoids the full operand pre-alignment and post-result normalization overhead of a conventional floating point adder (thereby obviating the full-width right and left shifters, deep multiplexing trees and associated circuitry required to steer intermediate values for the various operand cases) and instead implements a single small shift (up to 8 bits) and a single fixed-point addition. Accordingly, the coarse floating point adder/accumulator is substantially smaller (less than half the die area consumption) than conventional normalized-operand floating point adder circuits—having a shorter critical delay path between source and destination registers and consuming substantially less energy per floating-point addition operation. In the depicted example, the FC adder receives an FP32 multiplication product from a set of source registers 401—an input operand to be added to the running accumulation (MAC result) and having, in this example, a 1-bit sign SP, an 8-bit exponent EP[7:0], and a 23-bit sign-magnitude fraction FP[46:24]. The fraction is right-extended with zeroes in the FP[23:13] positions, and an OPp control input (programmed configuration value) conditionally inverts the SP sign bit to SP0. Note that the FIG. 11 adder/accumulator may readily be modified or programmatically configured to accept floating-point inputs with higher- or lower-precision floating-point formats (e.g., the internal data path of the adder may accommodate an FP40 or wider input product). If SP0=1 (i.e., the input operand is negative), the FP[51:13] fraction is conditionally inverted to FP0[51:13] within exclusive-OR circuitry 403 and the carry-in input CMPP1 to CPADD block 405 (lower right of FIG. 11) is set. The FP0[51:13] fraction is right-shifted by up to seven bit positions (this is called fine alignment) within shift circuit 407 in accordance with the inverted EP[2:0] field of the input operand. The SP0 value sets the value of the shift-input bits, and the shift-output bits are discarded (these 7 bits are a padded field and are not significant). The resulting FP3[51:13] fraction (i.e., output of right-shifter 407) is the coarsely-aligned, two's complement value of the product input (along with the EP[7:4] coarse exponent field).

Still referring to FIG. 11, the adder/accumulator block also receives, as a second operand, an FC35 accumulation value 411 (i.e., running total) that includes, in this example, a 5-bit coarse exponent EZ[7:3] and a 30-bit two's-complement fraction FZ[51:22], the latter being right-extended with zeroes in the FP[21:13] positions. An OPz control input (programmable as with all control inputs) enables selective negation of the FC35 accumulation operand—inverting the FZ[51] sign bit to SZO, inverting the FZ[51:13] fraction to FZ0[51:13] (e.g., in XOR circuitry 413, and setting the carry-in OPZ1 of CSADD block 415 if OPz=1. The FZ0[51:13] fraction is checked for fraction overflow (FOVFL) and fraction underflow (FUNFL) in detectors 417 and 419. When fractional overflow occurs (i.e., when FZ0[51]·FZ0[50], triggering FOVFL signal assertion), the FZ0[51:13] fraction is right-shifted by 8 bit places within fraction-adjust block 420, with an SZ0-valued shift-in bit (the same as FZ0[51]). The shift-output bits are discarded (these 8 bits are a padded field and are not significant) and the exponent field is incremented (421) to account for the fraction shift. Fractional underflow (FUNFL signal asserted by detector 419 when either FZ0[51:40] is 12′h000 or when FZ0[51:40] is 12′hFFF and EZ[7:3] is not 5′00) triggers an 8-bit left shift of the FZ0[51:13] fraction within block 420, with a shift-input of OPz (the same as FZ0[13]). The shift-output bits are discarded (these 8 bits are copies of the sign bit and are not significant) and the exponent field is decremented (423) to account for the fraction shift.

Continuing with FIG. 11, two 3-to-1 multiplexers 425, 427 are provided to distinguish the fractional overflow, underflow and in-range cases (i.e., FOVFL, FUNFL, NoOvflUnfl). Multiplexer 425 generates the adjusted exponent EZv[7:3] for the accumulation input (i.e., the incremented or decremented or unchanged EZ[7:3] value according to the FOVL/FUNFL/NoOvflUnfl condition indicated by the collective state of the FOVFL and FUNFL signals), while multiplexer 427 generates the adjusted fraction FZv[51:13] for the accumulation input—the right-shifted or left-shifted (or unchanged) FZ[51:13] value again according to the FOVL/FUNFL/NoOvflUnfl multiplexer-control input.

The exponents of the FP and FC operands (i.e., EP[7:3] and EZ[7:3]) are evaluated in a set of subtraction operations executed concurrently with the handling of the FP0[51:13] product fraction input and the FZ[51:13] accumulation fraction input (i.e., all three actions are executed in parallel with no logic interaction). The exponent evaluations are performed within six 5-bit subtractor circuits 430, a redundant subtractor arrangement that enables the six different possible cases to be evaluated simultaneously, with the detected case selected by multiplexing circuits 431 and 433 to yield RS[7:3]. More specifically, three of the six subtractor circuits (each of which may be an adder circuit with a sign invert at one input to yield a subtrahend) generate EP[7:3]-EZ[7:3] differences, and the other three subtractors generate the EZ[7:3]-EP[7:3] differences, with each individual subtractor within a given set having logic circuitry specific to a respective one of the three overflow, underflow and no overflow/underflow cases (i.e., FOVFL, FUNFL, and NoOvflUnfl, respectively). The FOVFL and FUNFL cases will cause the EZ[7:3] value to be incremented or decremented, respectively, within the arithmetic operation (which effectively yields a comparison result). Multiplexer circuitry 431 (e.g., implemented by two multiplexers) selects one of the three cases {FOVFL, FUNFL, NoOvflUnfl} according to states of the FOVFL and FUNFL signals outputting two 5-bit difference values (EPmEZ and EZmEP) and their respective 1-bit carry out signals (EPgeEZ and EZgeEP). The EPgeEZ carry out signal controls four 2-to-1 multiplexing operations within multiplexer circuitry 433, selecting between EPmEZ[7:3] and EZmEP[7:3] to generate the RS[7:3] right alignment shift value; selecting the larger of EP[7:3] and EZv[7:3] to constitute the EZq[7:3] final exponent value; selecting whichever of the two input fractions FP3[51:13] and FZv[51:13] has the larger exponent to be fraction FZn[51:13]; selecting whichever of the two input fractions FP3[51:13] and FZv[51:13] has the smaller exponent to be fraction FZs[51:13].

Still referring to FIG. 11, fraction FZs[51:13] is subject to right-alignment shift in circuit block 441 according to the RS[5:3] shift value (i.e., implementing a right-shift of {0,8,16,24,32,40,48,56} bit positions), shifting in bit-values having a logic state according to the

FZs[51] sign bit. The shift output (i.e., bits shifted out of FZs[51:13]) is applied to adjust the carry-inputs to the CSADD and CPADD blocks (415, 405)—circuit blocks that perform an addition of FZs[51:13], FZn[51:13] and FCRND[51:13], with the latter value (FCRND[51:13]) effecting the appropriate FC35 rounding to yield a tentative GFZt[51:22] fraction result and EZq[7:3] exponent result. Note that if the RS[7:6] upper shift amount field is {01,10,11}, the maximum shift of 1561 bit positions is applied. Also, in a special exponent overflow (EOVFL) case (which occurs when the EZ[7:3] input exponent value is equal to 5′b11111 and FOVFL is asserted, or when the EP[7:0] input exponent value is equal to 8′hFF), the Ezr[7:3] output value is 5′b11111, and the FZr[51:22] value is 30′h20000000 or 30′h1FFFFFFF.

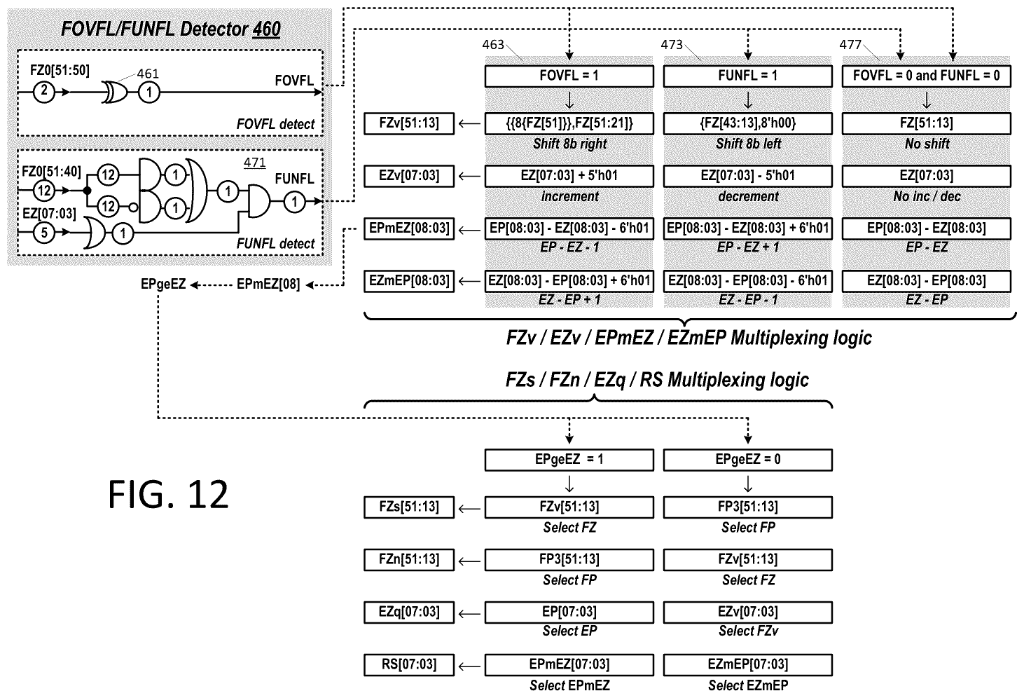

FIG. 12 illustrates additional control logic detail with respect to the overflow/underflow detect circuitry, FZv/EZv/EPmEZ/EZmEP multiplexing circuitry and FZs/FZn/EZq/RS multiplexing circuitry shown in FIG. 11. As discussed above, the overflow/underflow circuitry (460 in FIG. 12, corresponding to circuitry 417/419 in FIG. 11) generates the FOVFL/FUNFL signals that distinguish the fractional overflow, underflow and in-range (no overflow/underflow) cases. More specifically, FOVFL occurs when FZ0[51] FZ0[50] (detected by XOR gate 461), a circumstance that triggers operations shown at 463, including right-shifting of the FZ0[51:13] fraction by 8 bits with a shift-input of SZ0 (the same as FZ0[51]) and a discard of the shift-output bits (these 8 bits are a padded field and are not significant). The exponent field is incremented to account for the fraction shift. The fractional underflow case (i.e., FUNFL signal asserted by logic circuitry 471 when FZ0[51:40] is either 12′h000 or 12′hFFF and when EZ[7:3] is not 5′00) triggers the operations shown at 473, including left-shifting of the FZ0[51:13] fraction by 8 bits with a shift-input of OPz (the same as FZ0[13]) and discard of the shift-output bits (i.e., insignificant copies of the sign bit). The exponent field is decremented to account for the fraction shift. The two 3-to-1 multiplexers shown at 425 and 427 in FIG. 11 distinguish the {FOVFL, FUNFL, NoOvflUnfl} cases (operations for the latter shown at 477 in FIG. 12), with multiplexer 425 outputting either an incremented, decremented or unchanged instance of the EZ[7:3] value as the adjusted accumulation-input exponent EZv[7:3], and with multiplexer 427 outputting either an right-shifted, left-shifted or unchanged instance of the FZ[51:13] value as the adjusted accumulation-input fraction FZv[51:13].

Still referring to FIGS. 11 and 12, the two coarse exponents EP[7:3] and EZ[7:3] are compared within the six 5-bit subtractor circuits as discussed above. The redundant subtractor circuits allow six parallel difference cases to be developed simultaneously, with the correct case selected at the end. There are three adders that generate the (EP[7:3]-Z[7:3]) differences, and there are three adders that generate the (EZ[7:3]-EP[7:3]) differences. Each set of three adders generate the cases of {FOVFL, FUNFL, NoOvflUnfl}. The FOVFL and FUNFL cases will cause the EZ[7:3] value to be incremented or decremented, respectively, for the comparison. Two 3-to-1 multiplexers that are 6 bits wide use the FOVFL and FUNFL signals to select one of the three {FOVFL, FUNFL, NoOvflUnfl} cases. The multiplexer output are the EPmEZ and EZmEP differences, and the associated carry out signals (indicating EPgeEZ and EZgeEP). The EPgeEZ carry-out signal controls four 2-to-1 multiplexers 433 to (i) select either EPmEZ[7:3] and EZmEP[7:3] as the RS[7:3] right alignment shift value, (ii) select the larger of EP[7:3] and EZv[7:3] as the EZq[7:3] final exponent value, (iii) select fraction FZn[51:13] from the two fractions FP3[51:13] and FZv[51:13] (choosing the one with the larger exponent (EP[7:3] vs EZv[7:3]), and (iv) select the fraction FZs[51:13] from the two fractions FP3[51:13] and FZv[51:13] (choosing the one with the smaller exponent (EP[7:3] vs EZv[7:3]).

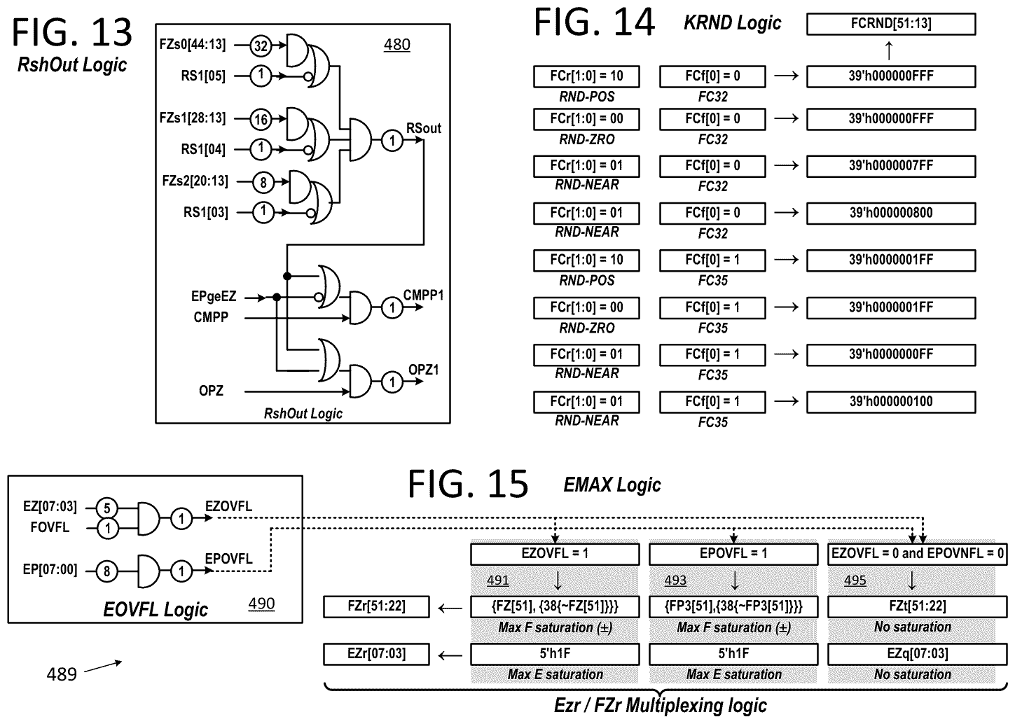

FIGS. 13, 14 and 15 illustrate exemplary implementations for the remaining control logic within the FC35 adder/accumulator circuit shown in FIG. 11. Referring to FIGS. 11 and 13, RshOut logic circuitry 480 generates the proper carry-in values, CMPP1 and OPZ1, for CPADD and CSADD blocks 405 and 415, respectively according to (i) the 32, 16 or 8 least-significant bits of the right-shifted fraction FZs[51:13] (i.e., generated by right-shift circuit 441); (ii) a RS1[5:3] value generated by logic circuitry 481 (set to all ‘1’s if either RS[7] or RS[6] is ‘1’ and otherwise equal to RS[5:3]); (iii) the OPz control input; the EPgeEZ result; and (v) the CMPP value generated by XOR gate 483 (indicating that the FP product operand is negative). The FP[51:13] fraction is conditionally inverted to FP0[51:13] (gate 403) and the carry-in CMPP1 to CPADD block 405 is set conditionally set. The OPz control input conditionally inverts the FZ[51] sign bit to SZ0 and also conditionally inverts the FZ[51:13] fraction to FZ0[51:13] and conditionally sets the carry-in OPZ1 to CSADD block 415 — inversions which collectively negate the value of the accumulation total. The CSADD and CPADD blocks perform an addition of FZs[51:13], FZn[51:13] and FCRND[51:13]. Rounding constant FCRND[51:13] performs the appropriate FC35 rounding to give the tentative GFZt]51:22] fraction result and EZq[7:3] exponent result. The rounding constant depends upon the output precision (FC35 or FC32) and the rounding mode (round-to-zero, round-to-nearest, round-to-positive-infinity, round-to-negative-infinity). FIG. 14 illustrates exemplary application of the FCf[0] and FCr[1:0] control inputs to determine the value of the FCRND[51:13] rounding constant.

The exemplary exponent-max-detect (EMAX) circuitry shown at 490 in FIGS. 11 and 15 includes overflow-detect circuitry 490 to detect two special exponent-overflow cases (EOVFL), asserting a first overflow-detect signal EZOVFL when the EZ[7:3] input exponent value is equal to 5′b11111 and FOVFL is high, and asserting a second overflow-detect signal EPOVFL when the EP[7:0] input exponent value is equal to 8′hFF. As shown at 491 and 493 in FIG. 15, EZr[7:3] is set to 5′b11111 (hexadecimal: 5′h1F) when either of the two overflow-detect signals is asserted, with FZr[51:22] set alternatively to 30′h10000000 or 30′h20000000 in response to EZOVFL or EPOVFL assertion. Where no EZOVFL or EPOVFL is detected, EZr[7:3] is set to EZq[7:3] and FZr[51:22] is set to FZt[51:22] as shown at 495. Multiplexers 497 and 499 within the FIG. 11 EMAX logic implement these selections, rending the selected results into output registers 500 (output registers external to the FCACC35 accumulator block).

Delays within critical timing paths will determine the pipeline clocking rate of the adder/accumulation circuit block shown in FIG. 11 (note that the two operand registers (SP/EP/FP and EZ/FZ) and the result register (Ezr/FZr) are external to the FCACC35 block — that is the FCACC35 block consists of only combinational logic disposed between the operand registers and result register and thus has no register storage/state). When the FP and FC operands are received, several independent, parallel actions are carried out including (for example and without limitation) including right-shifting the FZ[51:13] operand fraction by one byte and left-shifting that same operand fraction by one byte—operations that become relevant if the fraction is not coarsely normalized (i.e., the fraction has overflowed (FOVFL) or underflowed (FUNFL) a numeric window and requires a reduction by 1/256× or an increase by 256×). In a second one of the parallel operations with respect to received operands, the FOVFL and FUNFL cases trigger an increment or decrement of the EZ[07:03] operand exponent. In a third parallel operation, the EP[2:0] operand exponent field performs a fine alignment on the FP[51:13] operand fraction—this means that a right shift of {0,1,2,3,4,5,6,7} bit positions is performed. In a fourth parallel operation, the EP[7:3] operand exponent field and the EZ[7:3] operand exponent are compared. There are six parallel subtractions performed, consisting of the six cases {EP-EZ, EP-EZ+1, EP-EZ−1, EZ-EP, EZ-EP+1, EZ-EP−1}. The increment and decrement options are provided to handle the FOVFL and FUNFL sub-cases. In a fifth parallel operation, the FZ[51:13] operand fraction is checked for overflow and underflow, and the FOVFL and FUNFL signals are generated. These signals control four sets of 3-to-1 multiplexers and select the proper case from the three sets of FOVFL/FUNFL results. In a sixth parallel operation, the EPgeEZ signal is generated from carry out of the selected {EP-EZ, EP-EZ+1, EP-EZ−1} case and applied within the four sets of 2-to-1 multiplexers to select the proper case for the EP/EZ exponent compare. The results from the four sets of 2-to-1 multiplexers are passed to an alignment block which can perform a {0,1,2,3,4,5,6,7} byte shift of the FZs[51:13] fraction using the RS[7:3] shift value. This aligned result is added to the FZs[51:13] fraction with a rounding constant FCRND[51:13] to give the final fraction result FZr[51:22]. The final exponent result is Ezq[07:03]. A final set of multiplexers will substitute the appropriate constants in the case of exponent overflow.

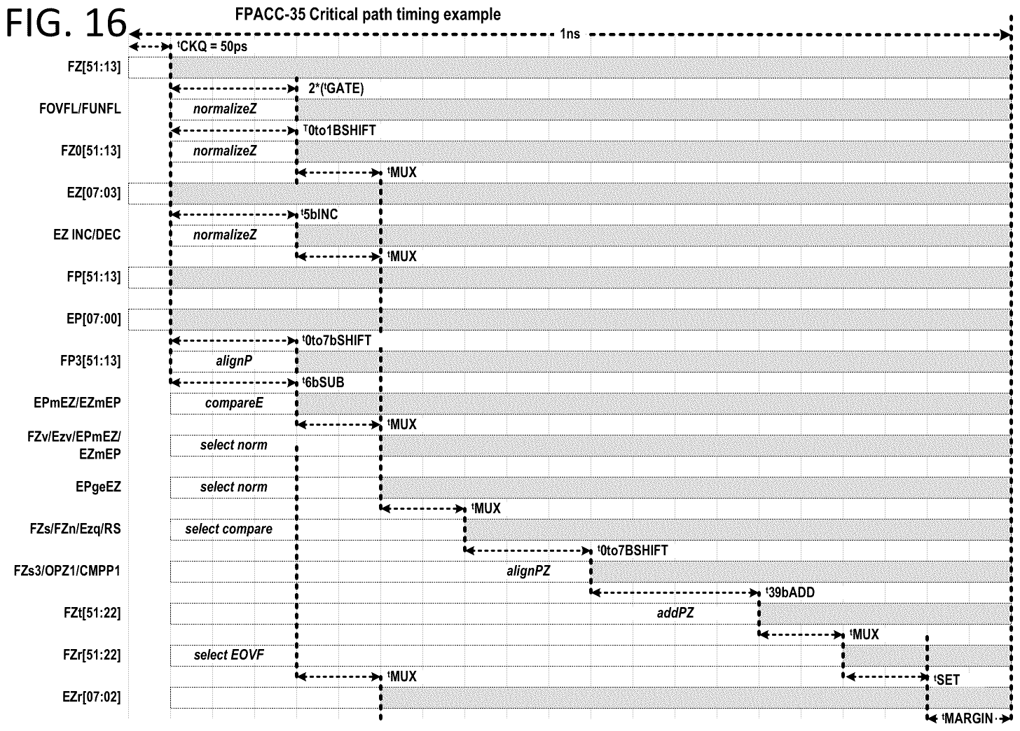

FIG. 16 illustrates an example of the timing waveform for the operations described in reference to FIGS. 11-15. The fraction and exponent fields of the operands (SP/EP/FP and EZ/FZ) settle a time tCKQ after the clock edge for the cycle (nominally 1 ns). Three of the waveforms are labeled “normalizeZ”, indicating the actions that are needed when FOVFL or FUNFL occurs with the fraction of the FZ operand. This includes a one byte shift (right or left) of FZ and an increment or decrement of the EZ exponent, (requiring times of “2*tGATE”, “t0to1BSHIFT”, and “t5bINC” in parallel). An “alignP” waveform indicates a fine alignment of the fraction of the FP operand—an alignment according to an exponent EP to perform a {0,1, . . . 7} bit right shift and requiring a time of “t0 to 7bSHIFT”. The “compareE” waveform triggers execution of the six subtractions of the EZ and EP exponents discussed above (each subtraction is six bits) in operations performed over time interval “t6bSUB”. The two “select norm” waveforms enable the four sets of 3-to-1 multiplexers to distinguish the FOVFL and FUNFL cases—multiplexing/selection operations implemented over time interval “tMUX”. The “select compare” waveform enables the four sets of 2-to-1 multiplexers to distinguish the exponent comparison cases in multiplexing operations implemented over another time interval “tMUX”. The “alignPZ” waveform triggers coarse alignment of one of the operand fractions in a {0,1,2,3,4,5,6,7} byte shift executed over time interval “t0 to 7BSHIFT”. The “addPZ” waveform enables summation (addition) of the two operand fractions—a 39-bit addition implemented over a time interval “t39bADD”. Waveform “select EOVF” is asserted to indicate that the fraction and exponent of the result are being adjusted because of an exponent overflow (requiring a time of “tMUX”). The FZr/Ezr results will then set up a pipeline register (requiring a time of “tSET”). The sum of the above-discussed time intervals add to the value of “tCKQ”-“tMARGIN”, where “tMARGIN” is the margin for the timing path.

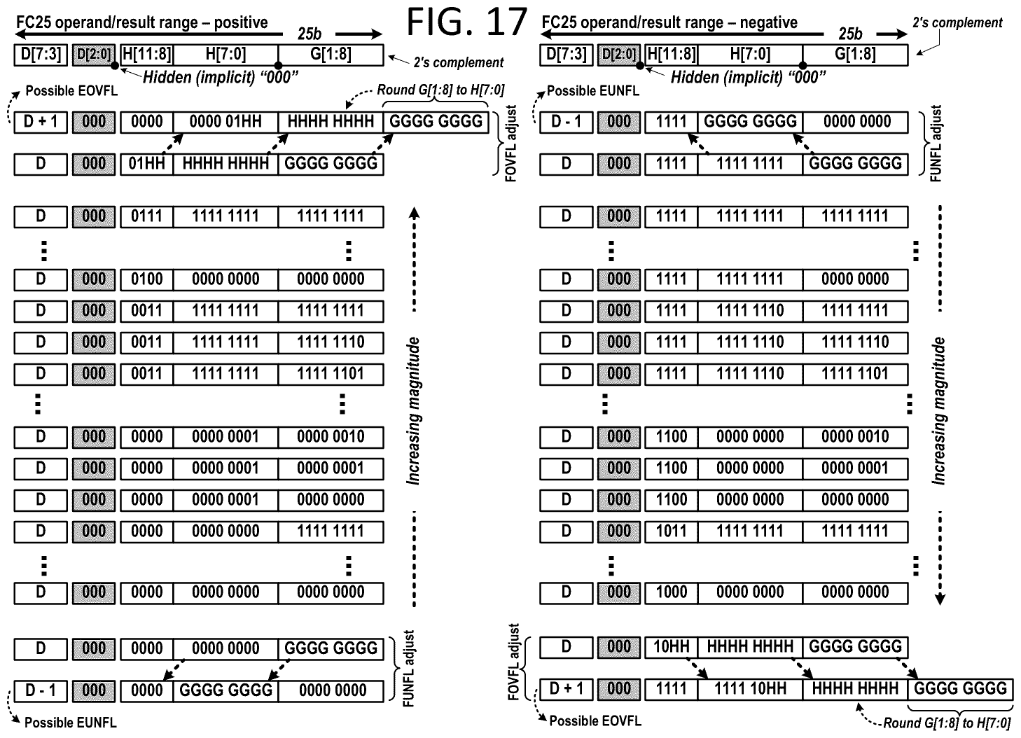

FIG. 17 illustrates an example of the range of operands and results accumulated in an exemplary FC25 format—intermediate values that include combinations of the H[11:8] field which are not 4′b0000 (positive) or 4′b1111 (negative) and thus a superset of the values that are produced when FP16 values are converted to FC25 values. As shown, the allowable positive values include combinations of the H[11:8] field which are 4′b00xx, and the allowable negative values include combinations of the H[11:8] field which are 4′b11xx—denoted within the positive-case FC25 values on the left side of FIG. 17 and within the negative-case FC25 values on the right side of FIG. 17. A positive result for which the H[11:8] field is 4′b01xx or a negative result for which the H[11:8] field is 4′b10xx indicates that a fraction overflow (FOVFL) has occurred. Conversely, a positive result for which the H[11:0] field is 12′h000 or a negative result for which the H[11:0] field is 12′hFFF indicates that a fraction underflow (FUNFL) has occurred. A result with FOVFL is corrected by right-shifting the H[11:0]/G[1:8] fields by 8 bit positions and incrementing exponent D[7:3] (such correction not performed until an FOVFL result is used as an operand in the subsequent accumulation operation). Note that sign bits are shifted-in, and the shifted-out bits will (eventually) be used for rounding. Also, note that the if D[7:3] increments to 5′b11111, an exponent overflow (EOVFL) will occur, with a result of ±INF. A result with FUNFL is corrected (again, not until the FUNFL result is used as an operand in the subsequent accumulation operation) by left-shifting the H[11:0]/G[1:8] fields by 8 bit positions and decrementing the exponent D[7:3]. Redundant sign bits are shifted-out and zero-valued bits are shifted in. If the D[7:3] value decrements to 5′b00000, an exponent underflow (EUNFL) will occur, yielding a result of ZERO.

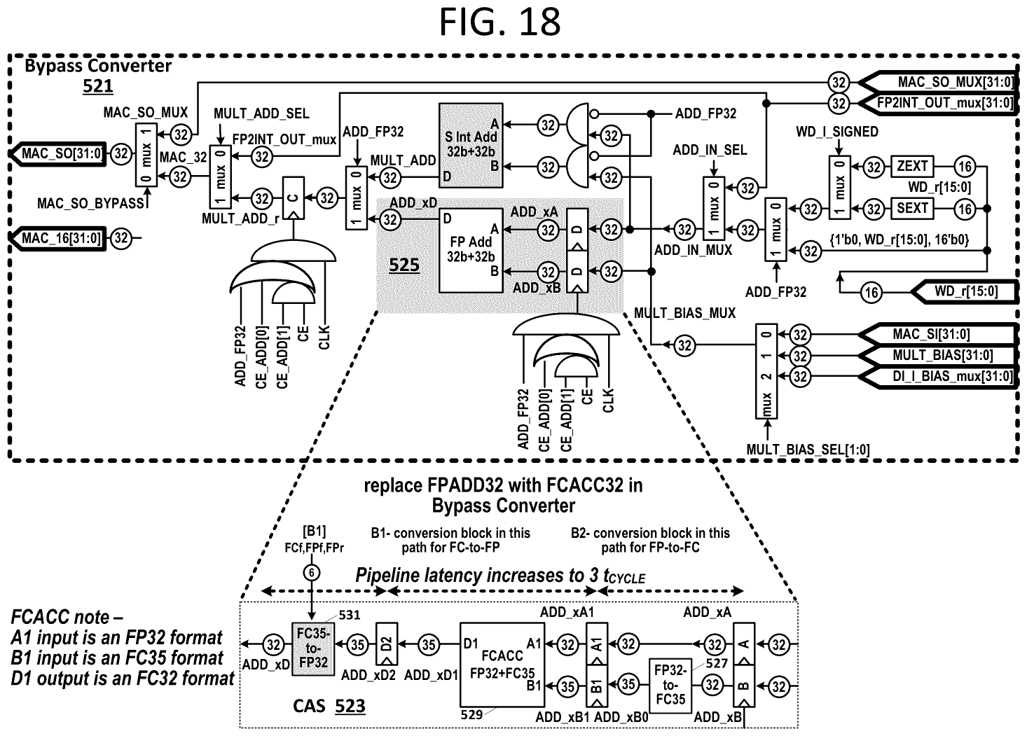

FIG. 18 illustrates a more detailed embodiment of FIG. 10 bypass converter 521. As shown, converter 521 includes a convert/add/restore block 523 (i.e., “CAS” 371, a replacement for FPADD32 component 525 of bypass converter 521) that adds two incoming FP32 operands to produce an FP32 sum—more specifically, converting incoming FP32 operand ADD_xB to FC32 format within operand converter 527, adding that formatted-converted operand (ADD_xB0) to FP32 operand ADD_xA within a coarse floating-point adder element 529 to produce an FC35 sum (ADD_xD1), and then converting (restoring) the FC35 sum to an FP32 result (ADD_xD) within format-restore converter 531. Various input and output formatting options for the bypass converter may be configured via programmable control inputs FCf, FPf, and FPr (e.g., control inputs driven from a shift register loaded from the configuration bus during system initialization and/or during run-time in preparation for a particular process execution). In the FIG. 10/FIG. 18 embodiments, the formatting options for the bypass converter block may be different (or the same) as those for the shift-out converter (i.e., converter 375 in FIG. 10). Also, one or more additional programmable configurations may be implemented within both converter blocks (375, 379) using the FPr control inputs. In a number of embodiments (or programmed configurations), for example, the “round-to-nearest-even” option will be selected, due to the fact that it gives the smallest addition/accumulation error. Other rounding options may be implemented in all cases to limit worst-case limit values for the rounding error (e.g., in conjunction with a numeric analysis of a particular set of filter coefficients for a model).

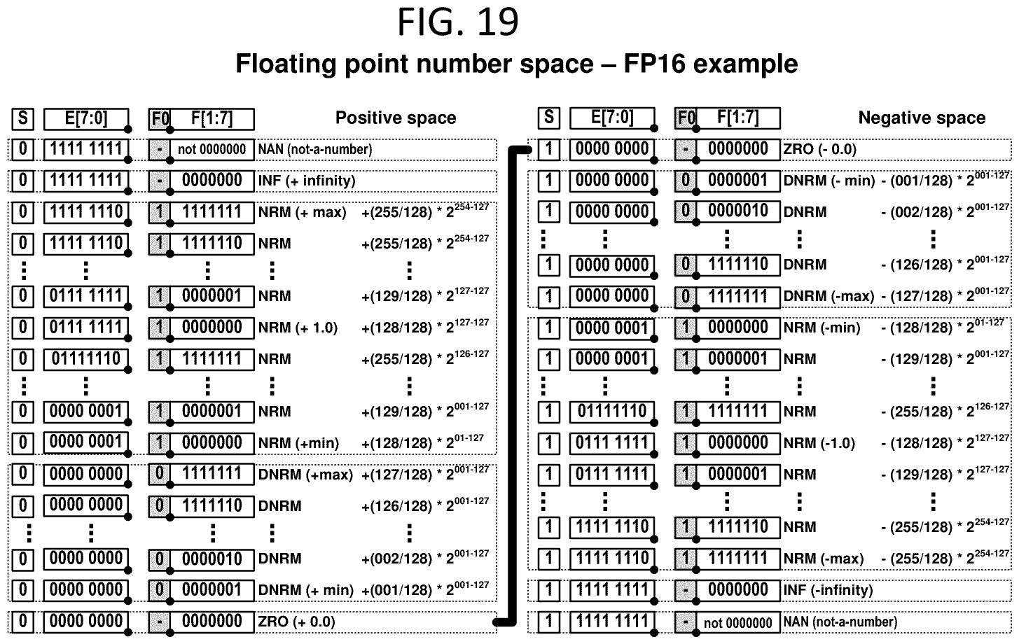

FIG. 19 illustrates an exemplary floating point number space for the FP16 format. The minimum and maximum exponent E[7:0] are reserved for special operands (NAN, INF, DNRM, ZERO). A NAN value (“not-a-number”) is generated when an undefined operation takes place (0*∞ or ∞−∞). The ±INF values (+∞ or −∞) are the saturation values for exponent overflow, and the ±ZRO values (zero) are the saturation value for exponent underflow. The ±DNRM values (denormalized floating point numbers) provide for gradual underflow between the smallest NRM value and the ZRO value.

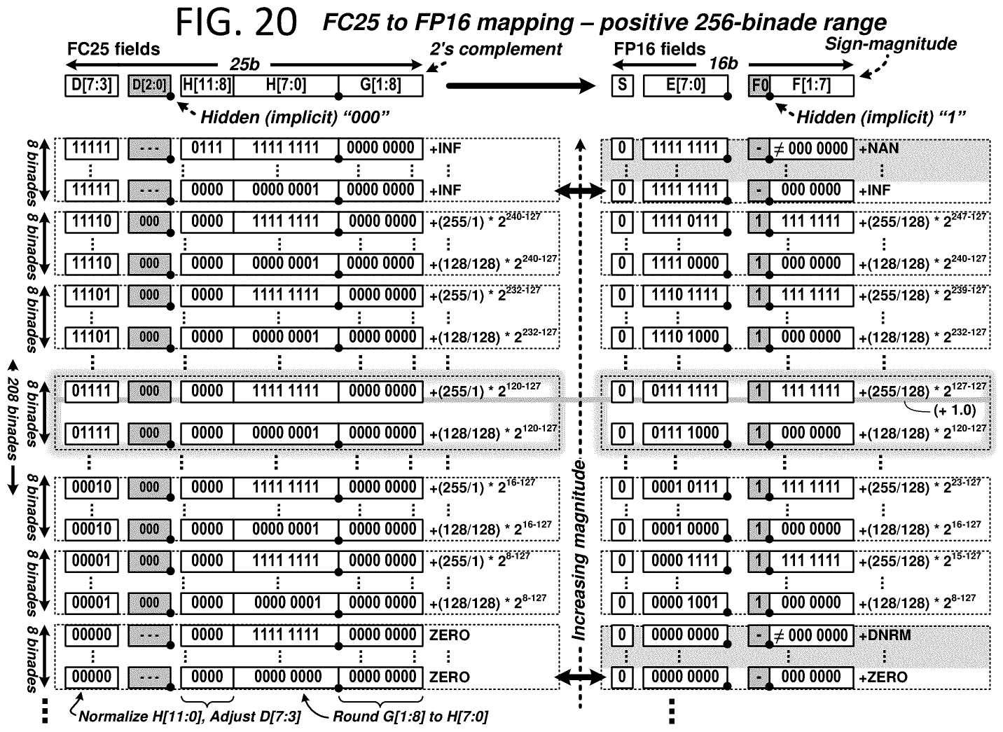

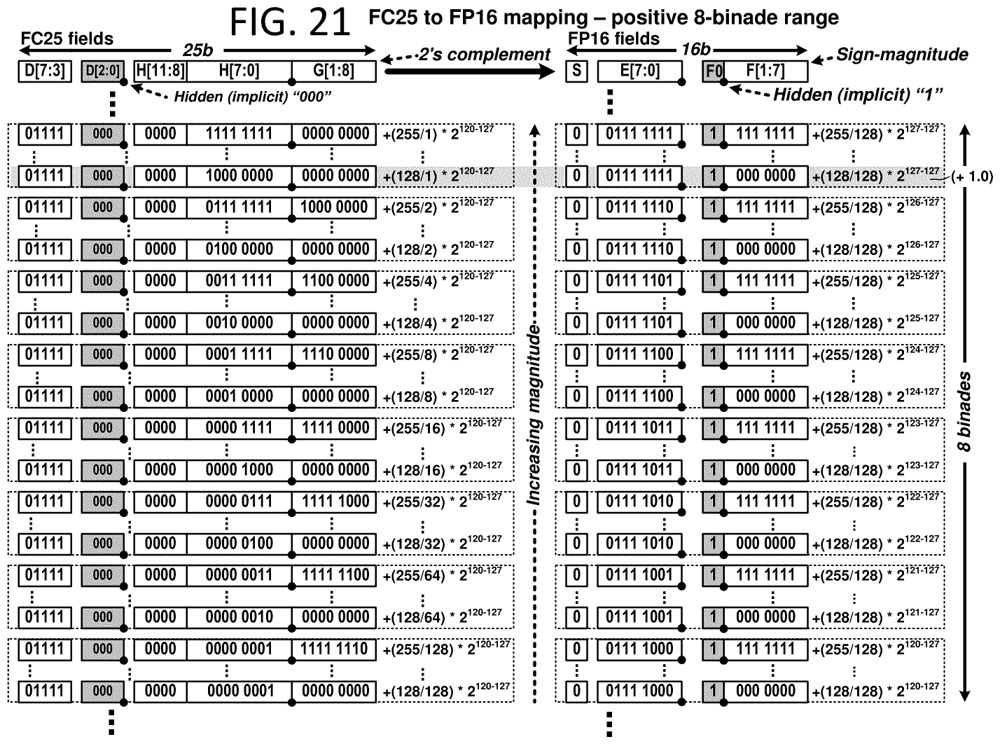

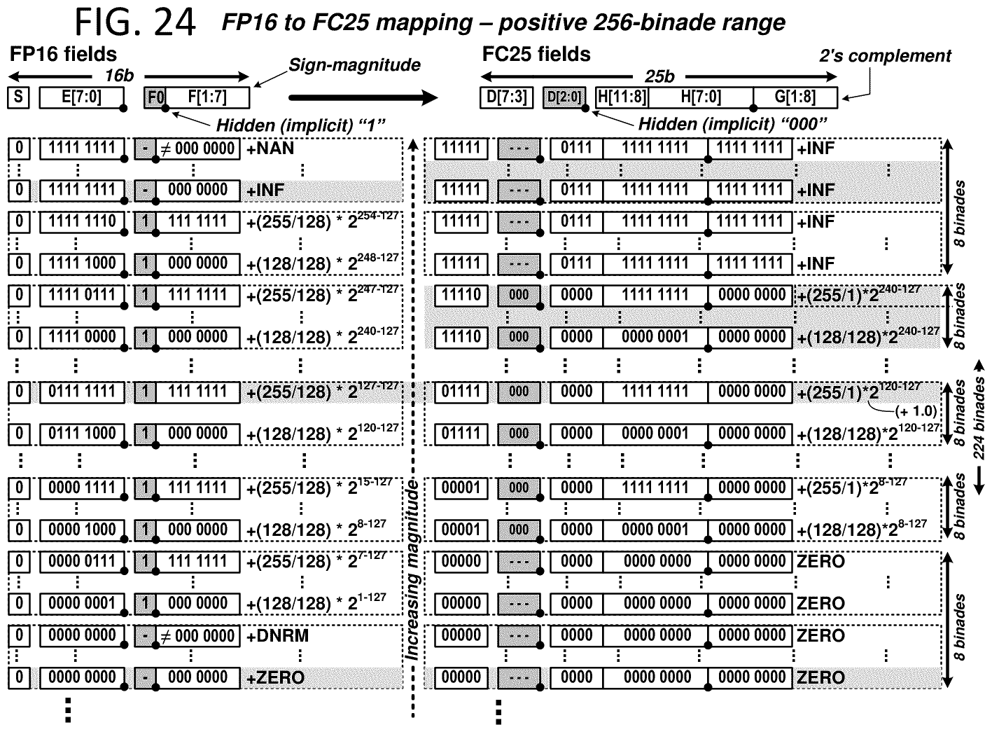

FIGS. 20-27 illustrate exemplary mapping between FC25 and FP16 formats—showing FC25 to FC16 mapping in FIGS. 20-23 and the reverse, FP16 to FC25 mapping, in FIGS. 24-27. Mapping between higher precision formats (e.g., FP32/FC32) is similar, but with wider fraction fields.

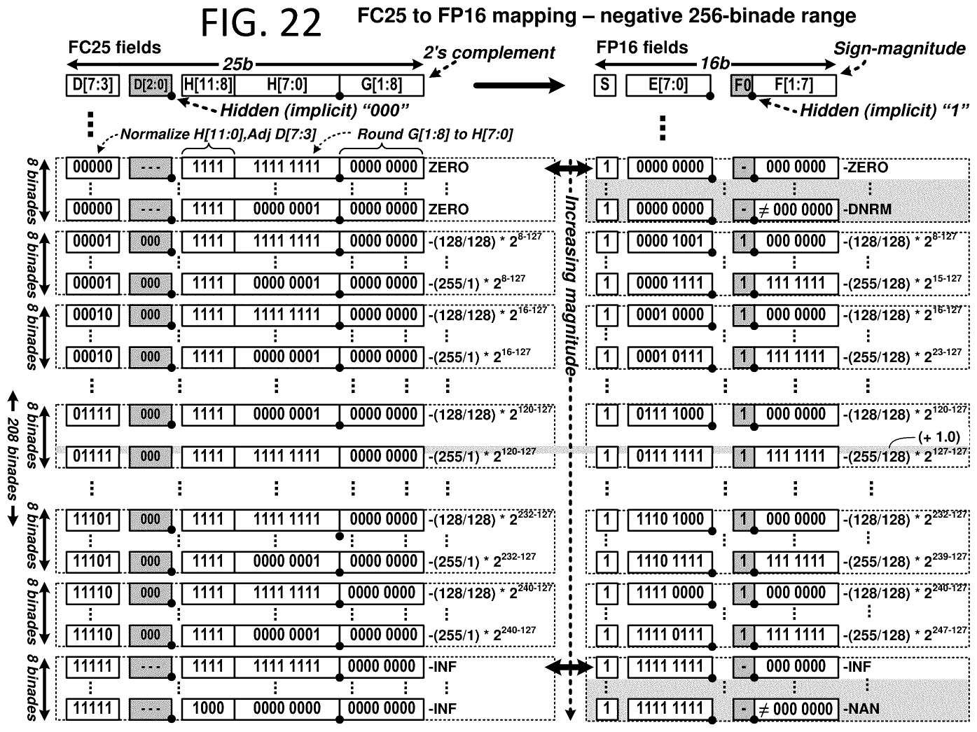

The FC25-to-FP16 mapping cases shown in FIG. 20 are grouped into blocks of eight binades (binades are powers-of-two). The first (uppermost) group of eight binades are all FC25 values with D[7:3] =5′b11111, representing the special +INF value for FC25 and mapped to the corresponding +INF value for FP16 (the +NAN values for FP16 are not produced). The last (bottom-most) group of eight binades are all FC25 values with D[7:3] =5′b00000, representing the special ZERO value for FC25 and mapped to the corresponding +ZERO value for FP16 (the +DNRMN values for FP16 are not produced). The middle 30 binade groups (240 binades in all) are all mapped in generally the same way as the first and last binade groups. FIG. 21 illustrates exemplary detail for one of those middle 30 binade groups—specifically the grey-shaded group marked by the +1.0 value and for which the FC25 fields in each of the eight binades in the group has a constant D[7:3] value of 5′b01111, and a hidden/implicit D[2:0] value of 3′b000. Values within the H[7:0] field increase from {8′b00000001 to 8′b11111111}, while the H[11:8] field is assumed to be 4′b0000 (the fraction has already been normalized and the exponent adjusted) and the G[1:8] field is assumed to be 8′b00000000 (the fraction has already been rounded (if necessary) to the proper size for conversion to FP16). Still referring to FIG. 21, the FP16 group containing the +1.0 value has a E[7:0] values in the range {8′b01111000 to 8′b01111111}, and F[0:7] values in the range {8′b10000000 to 8′b11111111}. Note that F[0] has a hidden/implicit value of 1′b1.

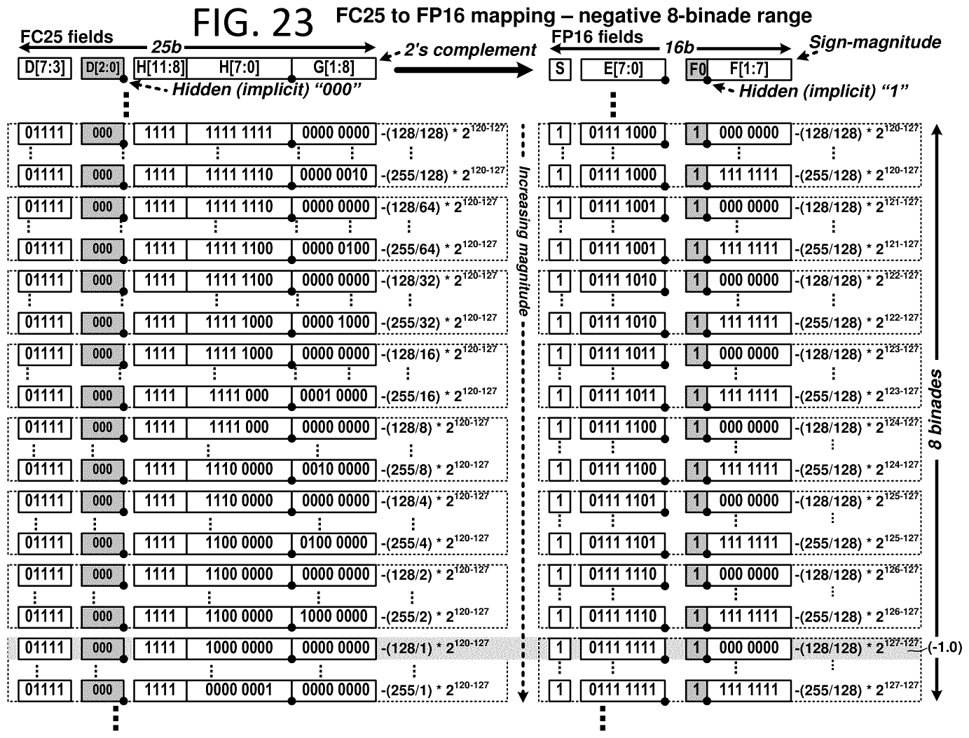

FIGS. 22 and 23 illustrate exemplary groups of binades for negative operands (i.e., the H[11:8] field is assumed to be 4′b1111). The FP16 fraction uses a sign-magnitude format, but the FC25 fraction is implemented as a two's complement value—a more optimal format during accumulation operations. In both FIGS. 22 and 23, the magnitude of the negative FP16/FC25 values increases in the downward direction (in contrast to the upward-direction increase in the magnitude of the positive FP16/FC25 values shown in FIGS. 20 and 21). The H[11:0]/G[1:8] fields of the FC25 values increase, for example, from {20′hFFF00 to 20′hFFE02} in the first binade in FIG. 16, with the grey-shaded −1.0 FC25 value shown as the last (bottom-most) binade.

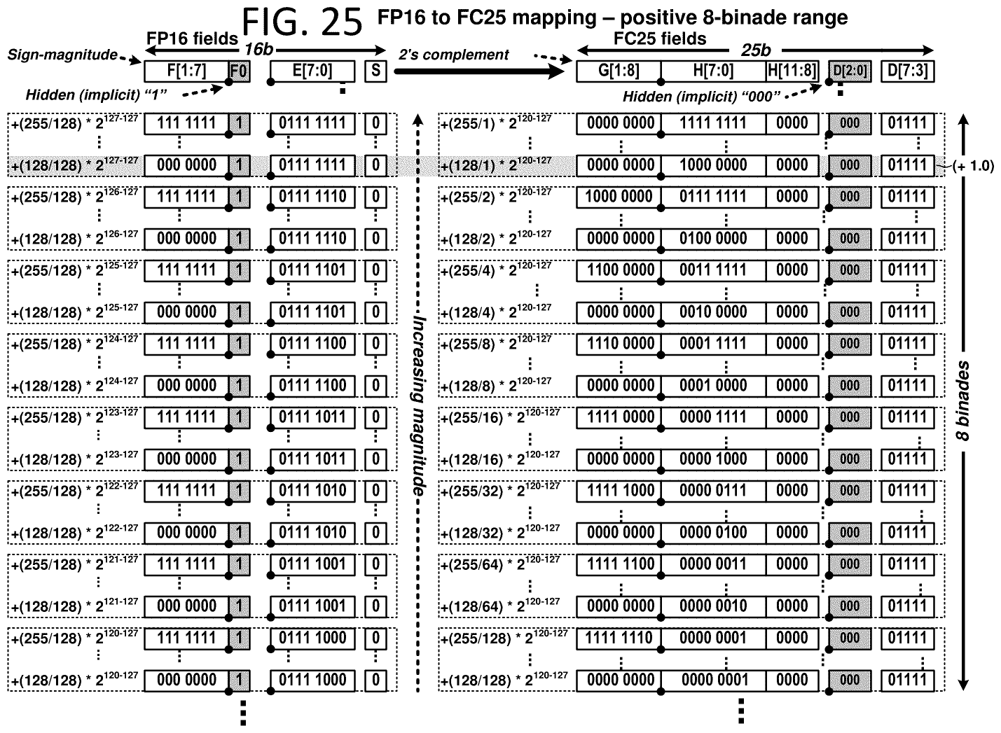

FIG. 24 illustrates exemplary mapping from standard floating-point format FP16 to coarse floating-point format FC25—the reverse of the mapping shown in the FIG. 20 example. The first (uppermost) group of eight binades are all FP16 values with E[7:3] =5′b111111, representing the special +NAN and +INF values for FP16 and mapped to the +INF value for FC25 (the largest positive value). The last (bottom-most) group of eight binades are all FP16 values with E[7:3] =5′b00000, representing the special +DNRM and +ZERO FP16 values (as well as normalized values less than 2 8-127) and mapped to the FC25 ZERO value (all zeros). FIG. 25 illustrates exemplary detail for one of the middle 30 binade groups in FIG. 24—specifically the grey-shaded group marked by the +1.0 value and for which the FP16 fields in each of the eight binades in the group has a constant E[7:3] field of 5′b01111, an E[2:0] field that increases from {3′b000 to 3′b111}, and an F[0:7] field increases from {8′b10000000 to 8′b11111111} (F[0] is a hidden bit with an implicit value of 1′b1 for normalized values).

Still referring to FIG. 25, the FC25 fields in each of the eight binades in the group have a constant D[7:3] value of 5′b01111, and a hidden/implicit D[2:0] value of 3′b000. The H[11:0]/G[1:8] fields increase, for example, from {20′h00100 to 20′h001FE} in the first binade. The other binades have a similar fraction range but are scaled by multiples of 2×. The additional 12 bit positions for the FC25 fraction enable fine alignment and fraction overflow detection during accumulation operations.

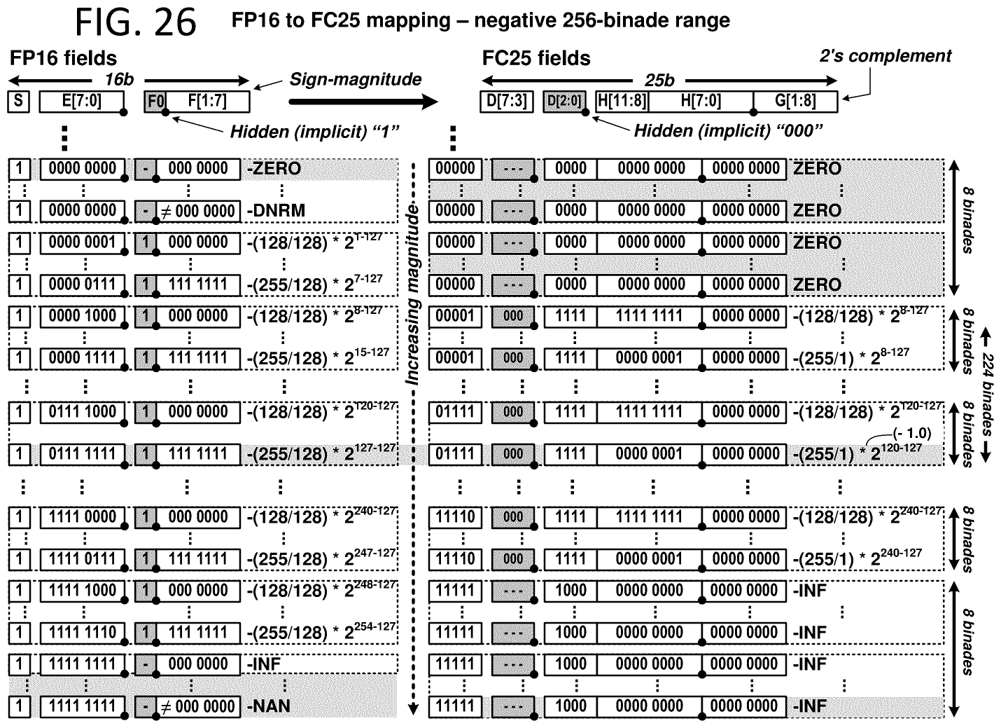

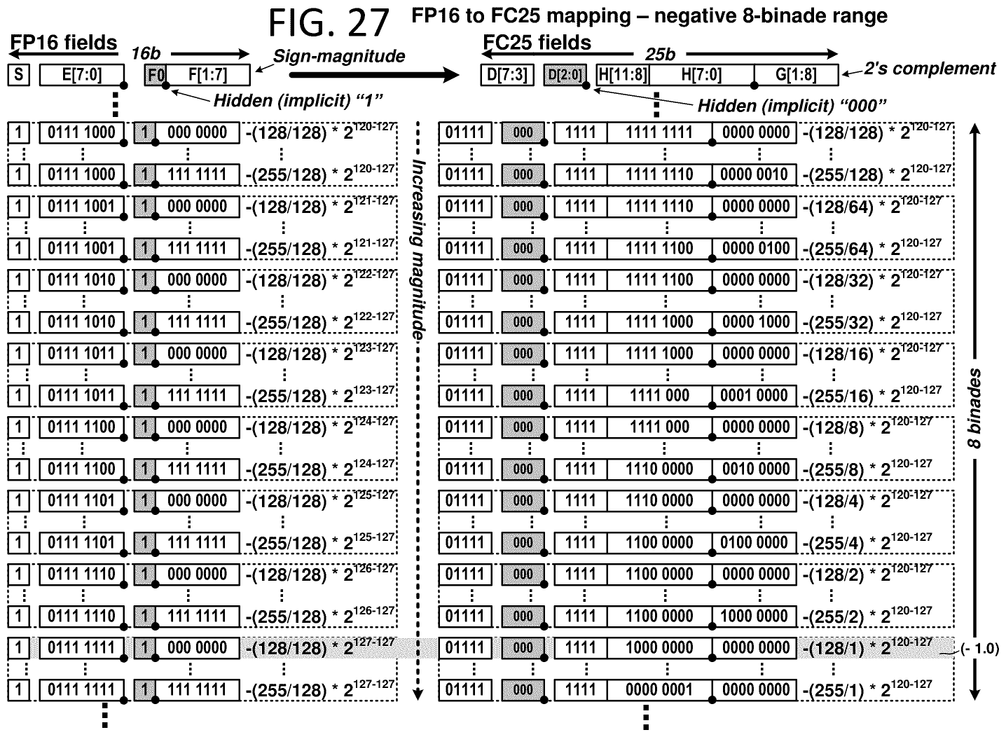

FIGS. 26 and 27 illustrate exemplary groups of binades for negative operands (the sign-bit field (‘S’) of the FP16 value is 1′b1). The FP16 fraction uses a sign-magnitude format, but the FC25 fraction uses a two's complement to enable more optimal/efficient sum-of-product accumulation. In both FIGS. 26 and 27, the magnitude of the negative FP16/FC25 values increases in the downward direction (contrast the upward-direction increase shown in FIGS. 24 and 25 for positive FP16/FC25 values). The H[11:0]/G[1:8] fields of the FC25 values increase, for example, from {20′hFFF00 to 20′hFFE02} in the first binade in FIG. 27 (which depicts the −1.0 FC25 value in grey shading).

Referring to FIGS. 1-27 generally, the exemplary inferencing IC architectures, hierarchical components thereof, physical signaling interfaces, numbers of tensor processing units, TPU implementations, numbers of MAC processors per TPU, number of broadcast data channels, data formats, data precisions, data-component bit-depths (e.g., fractional and/or exponential bit-depth in various standard and coarse floating-point formats), configurable options (including configurable format-conversion options), MAC processor implementation, memory type, amount and disposition etc. may vary in numerous details and in particular with regard to any specific numbers, dimensions, formats, time-intervals presented (quantities of tiles, quantities of TPUs, quantities MAC processors, quantities of broadcast data channels, quantities of MAC channels, quantities and architectures of merged and/or dedicated shift-out paths, bit depths, memory sizes, data formats, data precisions, matrix/array dimensions, tensor dimensions, sub-tensor dimensions, clock periods or frequencies, MAC cycles per vector multiply interval, etc.). Moreover, the various inferencing IC embodiments (and component circuits thereof) presented herein may be implemented within a standalone integrated circuit component or IC package, or within one or more IC components (including packages having multiple IC dies) that combines the inferencing and/or vector-multiply functionality thereof with one or more other functions (e.g., integrated-circuit processor, application-specific integrated circuit (ASIC), etc.). One or more programmed microcontrollers and/or dedicated hardware circuits (e.g., finite state machines, registered or combinational circuits, etc.) may implement and/or control all or part of the various architectural and functional circuit blocks within the inferencing ICs presented herein. Additionally, any or all of those architectural/functional elements (or circuit blocks) may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, computer storage media in various forms (e.g., optical, magnetic or semiconductor storage media). Various innovative embodiments and aspects thereof disclosed herein include, for example and without limitation, at least the following bulletized features (in which sub-bulleted subject matter corresponding to optional aspects/features):
Method and/or computing circuitry for performing floating point format conversion, which (i) receives an operand in a modified floating point format composed of numeric fields containing an un-normalized digital significand/fraction value and a second digital exponent value used for scaling, with a smaller field size than the first exponent, and (ii) generates a result in a standard floating point format composed of numeric fields containing a normalized digital significand/fraction value, a first digital exponent value used for scaling, and a sign value
   At least two of the foregoing method/circuitry instances are executed/present and use respective, different sets of control values
   The foregoing method and/or computing circuitry in which (or which is configured to):
      the result uses a sign-magnitude format for sign value and fraction value
      the operand uses a two's complement format for sign value and fraction value
      the result uses an exponent field of 8 bits
      the operand uses an exponent field of 5 bits
      the most-significant fraction bit of the normalized result is “hidden”; i.e. not included in the transport and storage format, but is added to the fraction value for the processing format
      all fraction bits of the un-normalized operand are “visible”; i.e. the transport and storage format of the fraction value is used directly for processing
      generate a result with more than one field size for the fraction value and sign value, including at least two of the following sizes: {8, 16, 24, 32, 40}
         a control value selects the format of the result
      accept an operand with more than one field size for the fraction value and sign value, including at least two of the following sizes: {11, 19, 27, 30, 35}
         a control value selects the format of the operand
         a control value selects the rounding mode used for the result
      the sign and fraction values of the operand are converted to an internal sign-magnitude sign and fraction value, including a conditional complement and increment operation
         the internal sign-magnitude sign and fraction value is shifted left by a priority-encode value, so that the left-most fraction field bit is high; i.e. normalized, and in which the priority-encode value is subtracted from a scaled value of the operand exponent to give a result exponent
         the operand exponent is scaled by a factor of eight
      generate a result that is quantized to the result precision with more than one rounding method, including at least two of the following methods: {round-to-zero, round-to-nearest-even, round-to-positive-infinity, round-to-negative-infinity}
         an appropriate rounding constant is generated for the result precision and for the rounding method, with the constant added to the internal sign-magnitude sign and fraction value to give a rounded sum
         the rounded sum is used to select between the result exponent and an incremented result exponent to give a corrected exponent, to correct for an overflow of the normalized fraction
         the corrected exponent is checked for the minimum value representing “zero”; if so, the result value is also forced to the minimum value representing “zero”
         the corrected exponent is checked for the maximum value representing “infinity”; if so, the result value is also forced to the maximum value representing “infinity”, with the sign value of the result set to match the sign value of the operand
         the corrected exponent of the operand is not a minimum or maximum value, and in which the rounded sum is masked to the precision size of the result fraction and sign value, and the result exponent value is set to the corrected exponent
Method and/or computing circuitry for performing floating point conversion, which (i) receives an operand in a conventional floating point format composed of numeric fields containing a normalized digital significand/fraction value, a first digital exponent value used for scaling and a sign value, and (ii) generates a result in a modified floating point format composed of numeric fields containing an un-normalized digital significand/fraction value, a second digital exponent value used for scaling (having a smaller field size than the first exponent) and a sign value
   At least two of the foregoing method/circuitry instances are executed/present and use respective, different sets of control values
   The foregoing method and/or computing circuitry in which (or which is configured to):
      the operand uses a sign-magnitude format for sign value and fraction value
      the result uses a two's complement format for sign value and fraction value
      the operand uses an exponent field of 8 bits
   the result uses an exponent field of 5 bits
   the most-significant fraction bit of the normalized operand is “hidden”; i.e. not included in the transport and storage format, but is added to the fraction value for the processing format
   all fraction bits of the un-normalized result are “visible”; i.e. the transport and storage format of the fraction value is used directly for processing
   accept an operand with more than one field size for the fraction value and sign value, including at least two of the following sizes: {8, 16, 24, 32, 40}
      a control value selects the format of the operand
   generate a result with more than one field size for the fraction value and sign value, including at least two of the following sizes: {11, 19, 27, 30, 35}
      a control value selects the format of the result
      a control value selects the rounding mode used for the result
   the sign and fraction values of the operand are converted to a wider internal two's complement sign and fraction value, including a conditional complement and increment operation
      the wider internal two's complement sign and fraction value is shifted right according to the complement of lower field of the exponent field of the operand, the size of this lower field equal to the difference in size of the exponent field of the operand and the exponent field of the result
         the lower field of the exponent field of the operand is 3 bits, and the wider internal two's complement sign and fraction value is at least seven bits wider than the field with the sign and fraction values of the operand
   generate a result that is quantized to the result precision with more than one rounding method, including at least two of the following methods: {round-to-zero, round-to-nearest-even, round-to-positive-infinity, round-to-negative-infinity}
      an appropriate rounding constant is generated for the result precision and for the rounding method, with the constant added to the wider internal two's complement sign and fraction value to give a rounded sum
      the increment for the [1i] two's complement conversion operation is performed during the addition of the appropriate rounding constant and the wider internal two's complement sign and fraction value
      the exponent field of the operand is checked for the minimum value representing “zero”; if so, the result value is also forced to the minimum value representing “zero”
      the exponent field of the operand is checked for the maximum value representing “infinity”; if so, the result value is also forced to the maximum value representing “infinity”, with the sign value of the result set to match the sign value of the operand
      the exponent field of the operand is not a minimum or maximum value, and in which the a rounded sum is masked to the precision size of the result fraction and sign value, and the result exponent value is set to the upper field of the exponent field of the operand
Method and/or computing circuitry for performing floating point addition, which receives 1st/2nd operands, in which a first operand includes exponent field width NE1 and fraction field width NF1 (e.g., first operand=SP/EP/FP, where ‘/’ denotes “and/or”), a second operand includes exponent field width NE2 and fraction field width NF2, (e.g., second operand =EZ/FZ), wherein the fraction of 2^{nd} operand is unnormalized (e.g., first significant bit may be in at least two possible positions in NF2 field), and during the time interval that the exponent fields {NE 1,NE2 } are compared, the fraction field NF2 is simultaneously normalized.
   The foregoing method and/or computing circuitry in which:
      the compare of exponent fields INE1,NE21 includes a simultaneous compare of exponent fields {NE1,NE2+K}, where K is at least one constant value
         the K values include {+1, 0, −1}
      the addition operation is an accumulation of the first operand to the second operand, and in which the second operand is the result from a previous accumulation
         exponent field width NE2 is less than exponent field width NE1
         fraction field width NR1 is less than fraction field width NR2
         the first operand is a multiply product in a standard floating point format
         the second operand is an accumulation result in a coarse floating point format
      the normalization of the fraction field NF2 is due to a previous addition operation, in which the fraction of the previous result was allowed to overflow by at least one bit position
         the normalization of the fraction field NF2 is performed by examining the bit values in this overflow region of NF2
      the 1^{st} operand has exponent field width NE1 ofeight bits, and in which the 2^{nd} operand has exponent field width NE2 of five bits
      the fraction field NF1 of 1st operand includes a sign bit, and is encoded with a sign-magnitude numeric format, and in which the fraction field NF2 of 2nd operand is encoded with a two's complement numeric format
      the NE2 exponent field is simultaneously incremented and decremented during the {NE1,NE2} exponent compare operation, with the incremented and decremented NE2 exponent values selected according to the normalization of the fraction field NF2
      the NR2 fraction field is simultaneously shifted left by Nc bit positions and shifted right by Nc bit positions during the {NE1,NE2} exponent compare operation, with the shifted left and shifted right NE2 exponent values selected according to the normalization of the fraction field NF2
         the value of Nc is the coarse shifting granularity, and has a value of eight bit positions
      the NE1 exponent field width is larger than the NE2 exponent field width, and in which the extra low order bits of the NE1 field are used to perform a (fine) alignment operation on fraction field NF1 during the {NE 1,NE2 } exponent compare operation
      the normalization operation of the fraction field NF2 of 2^{nd} operand can consist of a right (arithmetic) shift of the NF2 field, an (effective) increment of the exponent field NE2 of 2^{nd} operand, and a comparison of the incremented NE2 value to see if it is greater than the maximum saturation threshold (EOVFL/INF)
      the normalization operation of the fraction field NF2 of 2^{nd} operand can consist of a left (arithmetic) shift of the NF2 field, an (effective) decrement of the exponent field NE2 of 2^{nd} operand, and a comparison of the decremented NE2 value to see if it is less than the minimum saturation threshold (EUNFL/ZERO)
      the {NE1,NE2} exponent compare operation selects between the normalized NF2 fraction and the fine-aligned NF1 fraction, and in which the fraction with the smaller exponent is right-shifted by the {NELNE2} exponent difference
         the right shift of the fraction with the smaller exponent is in units of the coarse shifting granularity Nc, with shift values of {0, 1*Nc, 2*Nc, 3*Nc, 4*Nc, . . . }
         the value of the coarse shifting granularity Nc has a value of eight bit positions
      the NF1 and NF2 fractions (on of them right-shited coarsly) are added to give a result fraction FZ
         a rounding constant is also added with the NF1 and NF2 fractions to give a result fraction, in which the rounding constant includes a value needed for correct two's complement numeric format, and a value needed for delivering a result with the desired numeric precision
      the result fraction FZcan be un-normalized, in which the first significant bit value may be in a fraction sub-field that is a least two bit positions in width

When received within a computer system via one or more computer-readable media, such data and/or instruction-based expressions of the above described circuits and circuitry can be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image can thereafter be used in device fabrication, for example, by enabling generation of one or more masks that are used to form various components of the circuits in a device fabrication process.

In the foregoing description and in the accompanying drawings, specific terminology and drawing symbols have been set forth to provide a thorough understanding of the disclosed embodiments. In some instances, the terminology and symbols may imply specific details not required to practice those embodiments. For example, the various functional-element quantities (tiles, TPUs per tile, MAC processors per TPU, etc.), bit depths, memory sizes, tensor/matrix/sub-tensor dimensions, clock frequencies, data formats (including input data, filter weights and output data), and so forth are provided for purposes of example only—any practicable alternatives may be implemented in all cases. Similarly, physical signaling interfaces (PHYs) having any practicable link parameters, protocols and configurations may be implemented in accordance with any practicable open or proprietary standard and any version of such standard. Links or other interconnections between integrated circuit devices and/or internal circuit elements or blocks may be shown as buses or as single signal lines. Each of the buses can alternatively be a single signal line, and each of the single signal lines can alternatively be a bus. Signals and signaling links, however shown or described, can be single-ended or differential. Logic signals shown or described as having active-high assertion or “true” states, may have opposite assertion states in alternative implementations. A signal driving circuit is said to “output” a signal to a signal receiving circuit when the signal driving circuit asserts (or de-asserts, if explicitly stated or indicated by context) the signal on a signal line coupled between the signal driving and signal receiving circuits. The term “coupled” is used herein to express a direct connection as well as a connection through one or more intervening circuits or structures. Integrated circuit device or register “programming” can include, for example and without limitation, loading a control value into a configuration register or other storage circuit within the integrated circuit device in response to a host instruction (and thus controlling an operational aspect of the device and/or establishing a device configuration) or through a one-time programming operation (e.g., blowing fuses within a configuration circuit during device production), and/or connecting one or more selected pins or other contact structures of the device to reference voltage lines (also referred to as strapping) to establish a particular device configuration or operational aspect of the device. The terms “exemplary” and “embodiment” are used to express an example, not a preference or requirement. Also, the terms “may” and “can” are used interchangeably to denote optional (permissible) subject matter. The absence of either term should not be construed as meaning that a given feature or technique is required.

Various modifications and changes can be made to the embodiments presented herein without departing from the broader spirit and scope of the disclosure. For example, features or aspects of any of the embodiments can be applied in combination with any other of the embodiments or in place of counterpart features or aspects thereof. Accordingly, the specification and drawings are to be regarded in an illustrative rather than a restrictive sense.

What is claimed is:

1. An integrated circuit device comprising:
operand storage circuitry to output first and second operands each having a first standard floating point format;
multiplier circuitry to generate, by multiplying the first and second operands, a first multiplication product having a second standard floating point format, the second standard floating point format having a first numeric range; and
accumulator circuitry having:
format conversion circuitry to convert the first multiplication product to a second multiplication product having a coarse floating format with a second numeric range substantially smaller than the first numeric range;
summation circuitry to generate an updated accumulation value having the coarse floating point value by adding the second multiplication product to a previously generated accumulation value having the coarse floating point value; and
a result storage element to store the previously generated accumulation value, supply the previously generated accumulation value to the summation circuitry and, following generation of the updated accumulation value, to store the updated accumulation value in place of the previously generated accumulation value.

2. The integrated circuit device of claim 1 wherein the standard floating point format comprises an exponent field and a normalized fraction field, and the coarse floating point format comprises an exponent field and a non-normalized fraction field.

3. The integrated circuit device of claim 1 further comprising format restoration circuitry to receive, as a final accumulation value, the updated accumulation value stored within the result storage element, and to convert the final accumulation value to an accumulation result having the second standard floating point format.

4. The integrated circuit device of claim 1 wherein the second numeric range is less than half the first numeric range.

5. The integrated circuit device of claim 1 wherein the coarse floating format comprises a magnitude field that spans a first range of values, the first range of values extending to a maximum value greater than two.

6. The integrated circuit device of claim 1 wherein the coarse floating point format comprises an exponent field constituted by fewer bits than an exponent field of the standard floating point format.

7. An integrated circuit device comprising:
a plurality of multiply-accumulate circuit blocks each having:
an accumulator circuit to accumulate, over a plurality of multiply-accumulate cycles, respective multiplication products into a result value having a coarse floating point format having a first numeric range;
an output register into which the result value is loaded following a final multiply-accumulate cycle of the plurality of multiply-accumulate cycles, the output register being coupled in daisy-chain formation with output registers within others of the plurality of multiply-accumulate circuit blocks to collectively form a shift register containing the respective result values accumulated within each of the multiply-accumulate circuit blocks to iteratively output the respective result values; and
format conversion circuitry to convert each of the respective result values iteratively output from the shift register from the coarse floating point format to an equivalent result value having a first standard floating point format, the first standard floating point format having a second numeric range substantially larger than the first numeric range.

8. The integrated circuit device of claim 7 wherein the standard floating point format comprises an exponent field and a normalized fraction field, and the coarse floating point format comprises an exponent field and a non-normalized fraction field.

9. The integrated circuit device of claim 7 wherein the second numeric range is less than half the first numeric range.

10. The integrated circuit device of claim 7 wherein the coarse floating format comprises a magnitude field that spans a first range of values, the first range of values extending to a maximum value greater than two.

11. The integrated circuit device of claim 7 wherein the coarse floating point format comprises an exponent field constituted by fewer bits than an exponent field of the standard floating point format.

12. The integrated circuit device of claim 7 wherein the accumulator circuit within each of the multiply-accumulate circuit blocks comprises format conversion circuitry to convert each multiplication products from a second standard floating point format to the coarse floating point format.

13. A method of operation within an integrated circuit device, the method comprising:
receiving first and second operands each having a first standard floating point format;
generating, by multiplying the first and second operands, a first multiplication product having a second standard floating point format, the second standard floating point format having a first numeric range;
converting the first multiplication product to a second multiplication product having a coarse floating format with a second numeric range substantially smaller than the first numeric range;
generating an updated accumulation value having the coarse floating point value by adding the second multiplication product to a previously generated accumulation value having the coarse floating point value; and
storing the updated accumulation value in place of the previously generated accumulation value.

14. The method of claim 13 wherein the standard floating point format comprises an exponent field and a normalized fraction field, and the coarse floating point format comprises an exponent field and a non-normalized fraction field.

15. The method of claim 13 further comprising converting the updated accumulation value to an accumulation result having the second standard floating point format.

16. The method of claim 13 wherein the second numeric range is less than half the first numeric range.

17. The method of claim 13 wherein the coarse floating format comprises a magnitude field that spans a first range of values, the first range of values extending to a maximum value greater than two.

18. The method of claim 13 wherein the coarse floating point format comprises an exponent field constituted by fewer bits than an exponent field of the standard floating point format.

19. A method of operation within an integrated circuit device having a plurality of multiply-accumulate circuit blocks, the method comprising:
accumulating, within each of the multiply-accumulate circuit blocks over a plurality of multiply-accumulate cycles, respective multiplication products into a respective result value having a coarse floating point format having a first numeric range;
loading, within each of the multiply-accumulate circuit blocks following a final multiply-accumulate cycle of the plurality of multiply-accumulate cycles, the respective result value into an output register being coupled in daisy-chain formation with output registers within others of the plurality of multiply-accumulate circuit blocks to collectively form a shift register containing the respective result values accumulated within each of the multiply-accumulate circuit blocks to iteratively output the respective result values; and
converting each of the respective result values iteratively output from the shift register from the coarse floating point format to an equivalent result value having a first standard floating point format, the first standard floating point format having a second numeric range substantially larger than the first numeric range.

20. The method of claim 19 wherein the standard floating point format comprises an exponent field and a normalized fraction field, and the coarse floating point format comprises an exponent field and a non-normalized fraction field.

21. The method of claim 19 wherein the second numeric range is less than half the first numeric range.

22. The method of claim 19 wherein the coarse floating format comprises a magnitude field that spans a first range of values, the first range of values extending to a maximum value greater than two.

23. The method of claim 19 wherein the coarse floating point format comprises an exponent field constituted by fewer bits than an exponent field of the standard floating point format.

24. The method of claim 19 wherein the accumulator circuit within each of the multiply-accumulate circuit blocks comprises format conversion circuitry to convert each multiplication products from a second standard floating point format to the coarse floating point format.
